(19) United States
(12) Patent Application Publication
(10) Pub. No.: US 2026/0247214 A1
(43) Pub. Date: Aug. 20, 2026

(54) METHOD AND APPARATUS FOR DISCARDING PROTOCOL DATA UNIT (PDU) SET UNIT DOWNLINK PACKET IN SEPARABLE COMMUNICATION MOBILE BASE STATION

(71) Applicant: Samsung Electronics Co., Ltd., Gyeonggi-do (KR)

(72) Inventors: Beomsik BAE, Gyeonggi-do (KR); Hyunjeong KANG, Gyeonggi-do (KR); Taeseop LEE, Gyeonggi-do (KR)

(21) Appl. No.: 19/480,260

(22) PCT Filed: May 13, 2024
(86) PCT No.: PCT/KR2024/006461

§ 371 Date: Oct. 30, 2025

(30) Foreign Application Priority Data
May 11, 2023 (KR) 10-2023-0061293

(51) Int. Cl. H04W 28/06; H04W 12/10; H04W 28/02

(52) U.S. Cl. CPC H04W 28/06; H04W 12/10; H04W 28/0268

(57) ABSTRACT

The disclosure relates to a 5G or 6G communication system for supporting a higher data transmission rate. According to the present disclosure, network radio resources can be efficiently used by performing discarding of a downlink PDCP SDU in units of PDU sets in a separable base station.

### TECHNICAL FIELD

The disclosure relates to operations of a split mobile communication base station in a wireless communication system. Specifically, the disclosure relates to a method and an apparatus for efficiently servicing application data traffic in a wireless communication system.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an arca in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

In such next-generation mobile communication systems, there is a need for ways to efficiently use network radio resources.

### DISCLOSURE

### Technical Problem

An aspect of the disclosure is to provide an apparatus and a method capable of effectively providing services in a next-generation mobile communication system. More specifically, the disclosure relates to a method and an apparatus for down packet data convergence protocol service data unit discarding (hereinafter, referred to as “PDCP SDU discarding”) in a split base station (split radio access network architecture) of a next-generation mobile communication system. More particularly, the disclosure relates to a method and an apparatus for performing PDCP SDU discarding operations in units of a PDU set to efficiently utilize network radio resources when configuring a set of protocol data units (PDUs) (hereinafter, referred to as a “PDU set”) corresponding to an application data unit (ADU) in a 3GPP 5GS.

### Technical Solution

A method performed by a base station according to an embodiment of the disclosure to solve the above problems may include transmitting, by a central unit (CU)-control plane (CP), at least one information for performing protocol data unit (PDU) set discarding to a CU-user plane (UP), the at least one information for the PDU set discarding including discarding timer information, and performing, by the CU-CP, the PDU set discarding.

A base station according to another embodiment of the disclosure may include a controller which is configured to control a central unit (CU)-control plane (CP) to transmit, to a CU user plane (UP), at least one information for performing protocol data unit (PDU) set discarding, the at least one piece of information for the PDU set discarding including discarding timer information, and control the CU-CP to perform the PDU set discarding.

### Advantageous Effects

According to an embodiment of the disclosure, services can be effectively provided in a wireless communication system.

### DESCRIPTION OF DRAWINGS

FIG. 1 illustrates a structure of a next-generation mobile communication system to which the disclosure is applicable.

FIG. 2 illustrates a configuration of a protocol data unit (PDU) set according to an embodiment of the disclosure.

FIG. 3 is a sequence diagram illustrating operations and signaling procedures of respective nodes or functions to support an operation in which packet discarding in units of a PDU set can be performed by a CU-UP and a DU of an RAN node according to an embodiment of the disclosure.

FIG. 4 is a flowchart illustrating an operation of a CU-CP in an RAN node according to the embodiment of FIG. 3 of the disclosure.

FIG. 5A illustrates a configuration example of a BEARER CONTEXT SETUP REQUEST message used for an E1 interface and used in operation S340 of FIG. 3, to send a request for setup of a bearer context to a CU-UP from a CU-CP in an RAN node according to an embodiment of the disclosure.

FIG. 5B illustrates a configuration example of a BEARER CONTEXT SETUP REQUEST message used for an E1 interface and used in operation S340 of FIG. 3, to send a request for setup of a bearer context to a CU-UP from a CU-CP in an RAN node according to an embodiment of the disclosure.

FIG. 5C illustrates a configuration example of a BEARER CONTEXT SETUP REQUEST message used for an E1 interface and used in operation S340 of FIG. 3, to send a request for setup of a bearer context to a CU-UP from a CU-CP in an RAN node according to an embodiment of the disclosure.

FIG. 5D illustrates a configuration example of a BEARER CONTEXT SETUP REQUEST message used for an E1 interface and used in operation S340 of FIG. 3, to send a request for setup of a bearer context to a CU-UP from a CU-CP in an RAN node according to an embodiment of the disclosure.

FIG. 5E illustrates a configuration example of a BEARER CONTEXT SETUP REQUEST message used for an E1 interface and used in operation S340 of FIG. 3, to send a request for setup of a bearer context to a CU-UP from a CU-CP in an RAN node according to an embodiment of the disclosure.

FIG. 5F illustrates a configuration example of a BEARER CONTEXT SETUP REQUEST message used for an E1 interface and used in operation S340 of FIG. 3, to send a request for setup of a bearer context to a CU-UP from a CU-CP in an RAN node according to an embodiment of the disclosure.

FIG. 5G illustrates a configuration example of a BEARER CONTEXT SETUP REQUEST message used for an E1 interface and used in operation S340 of FIG. 3, to send a request for setup of a bearer context to a CU-UP from a CU-CP in an RAN node according to an embodiment of the disclosure.

FIG. 5H illustrates a configuration example of a BEARER CONTEXT SETUP REQUEST message used for an E1 interface and used in operation S340 of FIG. 3, to send a request for setup of a bearer context to a CU-UP from a CU-CP in an RAN node according to an embodiment of the disclosure.

FIG. 5I illustrates a configuration example of a BEARER CONTEXT SETUP REQUEST message used for an E1 interface and used in operation S340 of FIG. 3, to send a request for setup of a bearer context to a CU-UP from a CU-CP in an RAN node according to an embodiment of the disclosure.

FIG. 5J illustrates a configuration example of a BEARER CONTEXT SETUP REQUEST message used for an E1 interface and used in operation S340 of FIG. 3, to send a request for setup of a bearer context to a CU-UP from a CU-CP in an RAN node according to an embodiment of the disclosure.

FIG. 5K illustrates a configuration example of a BEARER CONTEXT SETUP REQUEST message used for an E1 interface and used in operation S340 of FIG. 3, to send a request for setup of a bearer context to a CU-UP from a CU-CP in an RAN node according to an embodiment of the disclosure.

FIG. 5L illustrates a configuration example of a BEARER CONTEXT SETUP REQUEST message used for an E1 interface and used in operation S340 of FIG. 3, to send a request for setup of a bearer context to a CU-UP from a CU-CP in an RAN node according to an embodiment of the disclosure.

FIG. 6A illustrates a configuration example of a BEARER CONTEXT MODIFICATION REQUEST message used for an E1 interface and used in operation S340 of FIG. 3, to send a request for modification of a bearer context to a CU-UP from a CU-CP in an RAN node according to an embodiment of the disclosure.

FIG. 6B illustrates a configuration example of a BEARER CONTEXT MODIFICATION REQUEST message used for an E1 interface and used in operation S340 of FIG. 3, to send a request for modification of a bearer context to a CU-UP from a CU-CP in an RAN node according to an embodiment of the disclosure.

FIG. 7A illustrates a configuration example of a UE CONTEXT SETUP REQUEST message, which is used for an F1 or W1 interface and used in operation S360 of FIG. 3, to send a request for setup of a UE context to a DU from a CU-CP in an RAN node according to an embodiment of the disclosure.

FIG. 7B illustrates a configuration example of a UE CONTEXT SETUP REQUEST message, which is used for an F1 or W1 interface and used in operation S360 of FIG. 3, to send a request for setup of a UE context to a DU from a CU-CP in an RAN node according to an embodiment of the disclosure.

FIG. 7C illustrates a configuration example of a UE CONTEXT SETUP REQUEST message, which is used for an F1 or W1 interface and used in operation S360 of FIG. 3, to send a request for setup of a UE context to a DU from a CU-CP in an RAN node according to an embodiment of the disclosure.

FIG. 7D illustrates a configuration example of a UE CONTEXT SETUP REQUEST message, which is used for an F1 or W1 interface and used in operation S360 of FIG. 3, to send a request for setup of a UE context to a DU from a CU-CP in an RAN node according to an embodiment of the disclosure.

FIG. 7E illustrates a configuration example of a UE CONTEXT SETUP REQUEST message, which is used for an F1 or W1 interface and used in operation S360 of FIG. 3, to send a request for setup of a UE context to a DU from a CU-CP in an RAN node according to an embodiment of the disclosure.

FIG. 7F illustrates a configuration example of a UE CONTEXT SETUP REQUEST message, which is used for an F1 or W1 interface and used in operation S360 of FIG. 3, to send a request for setup of a UE context to a DU from a CU-CP in an RAN node according to an embodiment of the disclosure.

FIG. 7G illustrates a configuration example of a UE CONTEXT SETUP REQUEST message, which is used for an F1 or W1 interface and used in operation S360 of FIG. 3, to send a request for setup of a UE context to a DU from a CU-CP in an RAN node according to an embodiment of the disclosure.

FIG. 7H illustrates a configuration example of a UE CONTEXT SETUP REQUEST message, which is used for an F1 or W1 interface and used in operation S360 of FIG. 3, to send a request for setup of a UE context to a DU from a CU-CP in an RAN node according to an embodiment of the disclosure.

FIG. 7I illustrates a configuration example of a UE CONTEXT SETUP REQUEST message, which is used for an F1 or W1 interface and used in operation S360 of FIG. 3, to send a request for setup of a UE context to a DU from a CU-CP in an RAN node according to an embodiment of the disclosure.

FIG. 8A illustrates a configuration example of a UE CONTEXT MODIFICATION REQUEST message, which is used for an F1 or W1 interface and used in operation S360 of FIG. 3, to send a request for modification of a UE context (bearer context) to a DU from a CU-CP in an RAN node according to an embodiment of the disclosure.

FIG. 8B illustrates a configuration example of a UE CONTEXT MODIFICATION REQUEST message, which is used for an F1 or W1 interface and used in operation S360 of FIG. 3, to send a request for modification of a UE context (bearer context) to a DU from a CU-CP in an RAN node according to an embodiment of the disclosure.

FIG. 9 illustrates an operation for performing a packet discarding operation in units of a PDU set by a CU-UP and a DU of an RAN node according to an embodiment of the disclosure.

FIG. 10 is a sequence diagram illustrating an operation for performing a packet discarding operation in units of a PDU set by a CU-UP and a DU of an RAN node according to an embodiment of the disclosure.

FIG. 11A illustrates a configuration example of a packet transmitted by the UPF 1036 to the CU-UP 1024 to support operation in units of a PDU set in operation S1010 of FIG. 10, and a configuration example of information included in a packet transmitted by the CU-UP 1024 to the DU 1026 to support operation in units of a PDU set in operation S1020, according to an embodiment of the disclosure.

FIG. 11B illustrates a configuration example of a packet transmitted by the UPF 1036 to the CU-UP 1024 in operation S1010 of FIG. 10 to support operation in units of a PDU set, and a configuration example of information included in a packet transmitted by the CU-UP 1024 to the DU 1026 in operation S1020 to support operation in units of a PDU set, according to an embodiment of the disclosure.

FIG. 11C illustrates a configuration example of a packet transmitted by the UPF 1036 to the CU-UP 1024 to support operation in units of a PDU set in operation S1010 of FIG. 10, and a configuration example of information included in a packet transmitted by the CU-UP 1024 to the DU 1026 to support operation in units of a PDU set in operation S1020, according to an embodiment of the disclosure.

FIG. 12A illustrates a configuration example of information included in a packet used by a DU 1026 to transfer PDU set discarding information to a CU-UP 1024 in operation S1070 of FIG. 10, according to an embodiment of the disclosure.

FIG. 12B illustrates a configuration example of information included in a packet used by a DU 1026 to transfer PDU set discarding information to a CU-UP 1024 in operation S1070 of FIG. 10, according to an embodiment of the disclosure.

FIG. 12C illustrates a configuration example of information included in a packet used by a DU 1026 to transfer PDU set discarding information to a CU-UP 1024 in operation S1070 of FIG. 10, according to an embodiment of the disclosure.

FIG. 12D illustrates a configuration example of information included in a packet used by a DU 1026 to transfer PDU set discarding information to a CU-UP 1024 in operation S1070 of FIG. 10 according to an embodiment of the disclosure.

FIG. 12E illustrates a configuration example of information included in a packet used by a DU 1026 to transfer PDU set discarding information to a CU-UP 1024 in operation S1070 of FIG. 10, according to an embodiment of the disclosure.

FIG. 12F illustrates a configuration example of information included in a packet used by a DU 1026 to transfer PDU set discarding information to a CU-UP 1024 in operation S1070 of FIG. 10 according to an embodiment of the disclosure;

FIG. 13 illustrates an operation for performing packet discarding in units of a PDU set in a CU-UP and a DU of an RAN node according to an embodiment of the disclosure.

FIG. 14 is a sequence diagram illustrating an operation for performing an operation of discarding packets in units of PDU sets in a CU-UP and a DU of an RAN node according to an embodiment of the disclosure.

FIG. 15A illustrates a configuration example of information included in a packet used by a CU-UP 1424 to transfer PDU set discarding information to a DU 1426 in operation S1470 of FIG. 14, according to an embodiment of the disclosure.

FIG. 15B illustrates a configuration example of information included in a packet used by a CU-UP 1424 to transfer PDU set discarding information to a DU 1426 in operation S1470 of FIG. 14, according to an embodiment of the disclosure.

FIG. 15C illustrates a configuration example of information included in a packet used by a CU-UP 1424 to transfer PDU set discarding information to a DU 1426 in operation S1470 of FIG. 14, according to an embodiment of the disclosure.

FIG. 15D illustrates a configuration example of information included in a packet used by a CU-UP 1424 to transfer PDU set discarding information to a DU 1426 in operation S1470 of FIG. 14, according to an embodiment of the disclosure.

FIG. 15E illustrates a configuration example of information included in a packet used by a CU-UP 1424 to transfer PDU set discarding information to a DU 1426 in operation S1470 of FIG. 14, according to an embodiment of the disclosure.

FIG. 15F illustrates a configuration example of information included in a packet used by a CU-UP 1424 to transfer PDU set discarding information to a DU 1426 in operation S1470 of FIG. 14, according to an embodiment of the disclosure.

FIG. 16 illustrates an operation for performing a packet discarding operation in units of a PDU set in a CU-UP and a DU of an RAN node according to an embodiment of the disclosure.

FIG. 17A illustrates a configuration example of a packet transmitted by a UPF to a CU-UP in operation 1640-1 of FIG. 16 to support operation in units of a PDU set, and a configuration example of information included in a packet transmitted by a CU-UP to a DU in operation 1640-2 to support operation in units of a PDU set, according to an embodiment of the disclosure.

FIG. 17B illustrates a configuration example of a packet transmitted by a UPF to a CU-UP to support operation in units of a PDU set in operation 1640-1 of FIG. 16, and a configuration example of information included in a packet transmitted by a CU-UP to a DU to support operation in units of a PDU set in operation 1640-2 of FIG. 16, according to an embodiment of the disclosure.

FIG. 18 is a block diagram illustrating a structure of an RAN node (e.g., base station) according to an embodiment of the disclosure.

FIG. 19 is a block diagram illustrating a structure of a UE according to an embodiment of the disclosure.

### MODE FOR INVENTION

In describing embodiments set forth herein, descriptions related to technical contents well-known in the art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Also, the size of each element does not completely reflect the actual size thereof. In the respective drawings, the same or corresponding elements are assigned the same reference numerals.

The advantages and features of the present disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference signs indicate the same or like elements.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the term “unit” refers to a software element or a hardware element, such as a field programmable gate array (FPGA) or an application specific integrated circuit (ASIC), and the “unit” may perform certain functions. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more CPUs within a device or a security multimedia card.

Hereinafter, embodiments of the disclosure will be described in detail with reference to the accompanying drawings. Also, in describing the disclosure, a detailed description of known functions or configurations will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

In the following description, terms for identifying access nodes, terms referring to network entities, terms referring to messages, terms referring to interfaces between network entities, terms referring to various identification information, and the like are illustratively used for the sake of descriptive convenience. Therefore, the disclosure is not limited by the terms as described below, and other terms referring to subjects having equivalent technical meanings may also be used.

In the following description of the disclosure, terms and names defined in the 3rd generation partnership project new radio (3GPP NR) or 3GPP long term evolution (3GPP LTE) standards will be used for the sake of descriptive convenience. However, the disclosure is not limited by these terms and names, and may be applied in the same way to systems that conform other standards. In the disclosure, the term “gNB” may be interchangeably used with the term “eNB” for the sake of descriptive convenience. That is, a base station described as “eNB” may refer to “gNB”. Furthermore, the term “terminal” may refer to not only a mobile phone, an MTC device, an NB-IOT device, and a sensor, but also other wireless communication devices.

In the following description, a base station is an entity that allocates resources to terminals, and may be at least one of a gNode B (gNB), an eNode B (eNB), a Node B, a base station (BS), a wireless access unit, a base station controller, and a node on a network. A terminal may include a user equipment (UE), a mobile station (MS), a cellular phone, a smartphone, a computer, or a multimedia system capable of performing a communication function. Of course, examples of the base station and the terminal are not limited to those mentioned above.

The disclosure relates to a method and an apparatus for packet data convergence protocol service data unit (PDCP SDU) discarding (hereinafter, referred to as PDCP SDU discarding) in a next-generation mobile communication system. More specifically, the disclosure relates to a method and an apparatus which, when configuring a set of protocol data units (PDU) (hereinafter, a PDU set) corresponding to an application data unit (ADU) in 3GPP 5G, perform PDCP SDU discarding operations in units of a PDU set in order to efficiently use network radio resources.

The disclosure proposes a PDU set integrated handling parameter and a PDU set importance parameter as various quality of service (QOS) parameters for a protocol data unit (PDU) set, which may be used to guarantee QoS in units of a PDU set, and describes a method for adaptively performing PDU set discarding operation according to various PDU set configurations.

The disclosure relates to a method for performing a PDU set discarding operation, and more specifically, to a method for indicating a PDU set discarding operation in units of a PDU set and a method for indicating a PDU set discarding operation in units of a PDU, among a CU-CP, a CU-UP, and a DU in a split base station, and to a method including performing PDU set discarding by the CU-UP or the DU, transferring PDU set discarding information, and, after receiving the PDU set discarding information, performing a packet discarding operation in units of a PDU set.

Through the disclosure, a base station may configure control information for a PDU set discarding operation of a UE and the base station, based on QoS requirements of a PDU set and QoS parameters (for example, PDU set integrated handling and PDU set importance), and may exchange the configured control information with the UE. For example, the base station may transmit the configured control information to the UE. The UE may report, to a base station (e.g., a gNB), whether a PDU set discarding operation is supported, through UE capability information. The base station (e.g., gNB) may refer to UE capability information reported by a UE to instruct the UE to perform a PDU set discarding operation, and the UE may perform the PDU set discarding operation according to the instruction of the base station.

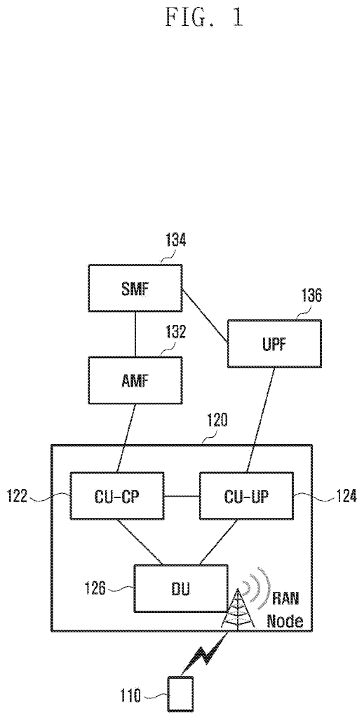

FIG. 1 illustrates a configuration example of a next-generation mobile communication system to which the disclosure may be applied. A radio access network (RAN) node 120 indicated in the structure illustrated in FIG. 1 may be a mobile communication base station connected to a core network (CN) such as a 5G core network (5GC). For example, the RAN node 120 may be an LTE eNB or an NR gNB. The UE 110 may be connected to a base station (RAN node) 120 through a radio interface (e.g., a Uu interface), and may transmit and receive control plane signaling (e.g., radio resource control (RRC) signaling) and user plane data (e.g., an internet protocol (IP) packet).

The RAN node 120 may be connected to the core network through an interface such as next generation (NG), and may also be connected to another RAN node (not illustrated) through an interface such as Xn. The RAN node 120 may include a central unit (CU) and a distributed unit (DU) 126. In an embodiment, the RAN node 120 may be configured by one CU and one or more DUs 126 connected to the CU, or may be configured by other combinations. The CU and the DU 126 may separately support the respective base station functions. For example, the CU may support a radio resource control (RRC) layer and a packet data convergence protocol (PDCP) layer, and the DU 126 may support a radio link control (RLC) layer, a medium access control (MAC) layer, and a physical (PHY) layer.

An interface between functional entities within a base station, such as an FI or WI interface, may be connected between the CUS 122 and 124 and the DU 126. In an embodiment, the CU may be configured by a single CU-control plane (CP) 122 responsible for a control function and one or more CU-user planes (Ups) 124 for user packet processing, and the DU 126 may be configured by separating a part supporting RLC/MAC/High-PHY and a part supporting Low-PHY/RF layers.

In addition, FIG. 1 illustrates functions or entities among various functions or entities of a core network, which are related to the disclosure, and the following description relates to some of the contents supported by the functions and entities, which are related to the disclosure. FIG. 1 illustrates a 5G core network (5GC) as an example of a core network. An access and mobility management function (AMF) 132 included in the 5GC is connected to the RAN node 120 through a next generation (NG) interface (or N2 interface) and may exchange control signals with the RAN node 120. A session management function (SMF) 134 is responsible for session control for user service provision, and a user plane function (UPF) 136 performs functions of exchanging user data through the RAN node 120. Although not illustrated in FIG. 1, the core network may also include other functions and entities, such as a policy control function (PCF), a unified data management (UDM), and an authentication server function (AUSF).

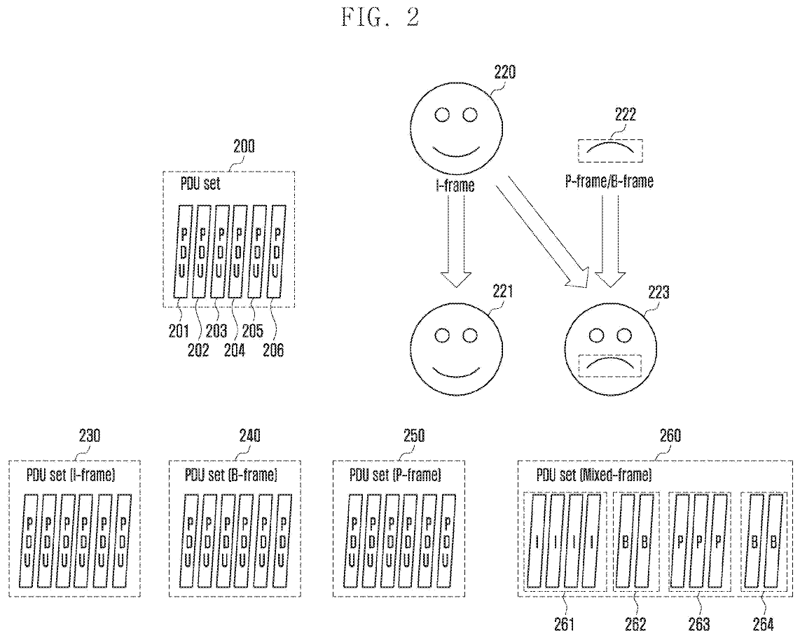

FIG. 2 illustrates a configuration of a protocol data unit (PDU) set according to an embodiment of the disclosure. Referring to FIG. 2, various types of traffic may be distinguished as application data units (ADUs), which are units of information distinguishable at the application level. For example, an ADU may be one image or picture, one frame of video, or one unit of audio. The ADU may be divided in units of a PDU set 200, and the PDU set 200 may be transmitted after being divided into one or more PDUs 201, 202, 203, 204, 205, and 206.

For example, in case of using a moving picture experts group (MPEG) standard video compression technology in video traffic, a PDU set may be configured by one of 1) a combination 230 of a plurality of PDUs corresponding to a single intra (I)-frame 220, 2) a combination 240 of a plurality of PDUs corresponding to a single bidirectional (B)-frame, 3) a combination 250 of a plurality of PDUs corresponding to a single predicted (P)-frame, and 4) a combination 260 of a plurality of PDUs corresponding to an ADU including a plurality of I-frames 261, B-frames 262 and 264, and/or P-frames 263. The I-frame 220 may represent a single complete photo or image 221, regardless of the presence or absence of other frames, as an independent frame. A P-frame and a B-frame 222 are frames indicating changed information of a previous I-frame 220. If the I-frame 220 is not normally received, a photo or a picture 223 which is to be expressed by the P-frame and the B-frame 222 may be difficult to normally express. In the case of a B-frame, since the B-frame is interposed between an I-frame and a P-frame and stores inferred data by referring to both frames in order to estimate movement between the two frames, the photo or image that is to be represented by the B-frame can be properly expressed only when not only the preceding I-frame but also the following P-frame is normally received.

In an embodiment of the disclosure, for the sake of descriptive convenience, a configuration of a PDU set and a PDU set discarding operation may be described by exemplifying a case in which an MPEG standard video compression technology is used in video traffic. However, the content of the disclosure is not limited to the PDU set configuration in video traffic, and may be applied to all PDU set configurations including general ADU units.

In an embodiment of the disclosure, discarding packets in units of a PDU set in a base station (RAN node) may be performed by a CU-UP or DU in the base station. Discarding packets in units of a PDU set may refer to “packets that have not yet been transmitted” among packets (or referred to as PDUs) constituting a PDU set, or may refer to “packets having PDCP sequence numbers (SNs) higher than those of discarded packets”. Discarding packets in units of a PDU set may reduce radio resource usage, unnecessary packet processing and storage in the base station, or resource waste for forwarding unnecessary packets between the CU-UP and the DU, when transmission of the PDU set is no longer meaningful due to a packet being discarded, even though the PDU set is configured by any one of the packets. One example of a method of discarding packets in units of a PDU set by a CU-UP or DU in the base station is as follows, and packets may be discarded in units of a PDU set by other methods not described herein.
When a specific packet among the packets (or referred to as PDUs) constituting a PDU set is discarded due to an expiration of a discard timer configured for each packet unit (or when the specific packet is discarded), a PDU set discarding operation is performed to discard the remaining packets constituting the same PDU set.
When a specific packet among packets (or referred to as PDUs) constituting a PDU set is discarded (or expired) due to an expiration of a PDU set discard timer configured for the packets included in the PDU set, a PDU set discard operation is performed to discard the remaining packets constituting the same PDU set.
Only when PDU set integrated handling indication (or PDU set integrated handling) indicating that if at least one packet belonging to the PDU set fails to be successfully transmitted, the remaining packets belonging to the corresponding PDU set are regarded as meaningless, is configured, and if a specific packet among the packets (or referred to as PDUs) that constitute the PDU set is discarded, a PDU set discard operation of discarding the remaining packets that constitute the same PDU set is performed.
Based on a PDU set importance value, which is information indicating the importance of each PDU set, a PDU set discard operation is performed with respect to a PDU set having an importance value configured to be lower than a reference value of a configured PDU set importance, the PDU set discard operation discarding the remaining packets constituting the same PDU set when a specific packet among packets (or referred to as PDUs) constituting the PDU set is abandoned (or discarded). Conversely, based on a reference value of a configured PDU set importance, a PDU set discard operation is performed with respect to a PDU set having an importance value configured to be higher than the reference value, the PDU set discard operation discarding the remaining packets constituting the same PDU set when a specific packet among the packets (or referred to as PDUs) constituting the PDU set is abandoned (discarded).
When packets (or referred to as PDUs) constituting the PDU set are abandoned (or discarded) by a configured reference number or more, a PDU set discard operation is performed to discard the remaining packets constituting the same PDU set.
When a specific packet is abandoned (or discarded) due to an expiration of a discard timer configured for each packet unit, a PDU set discard operation is performed to discard the remaining packets constituting the same PDU set

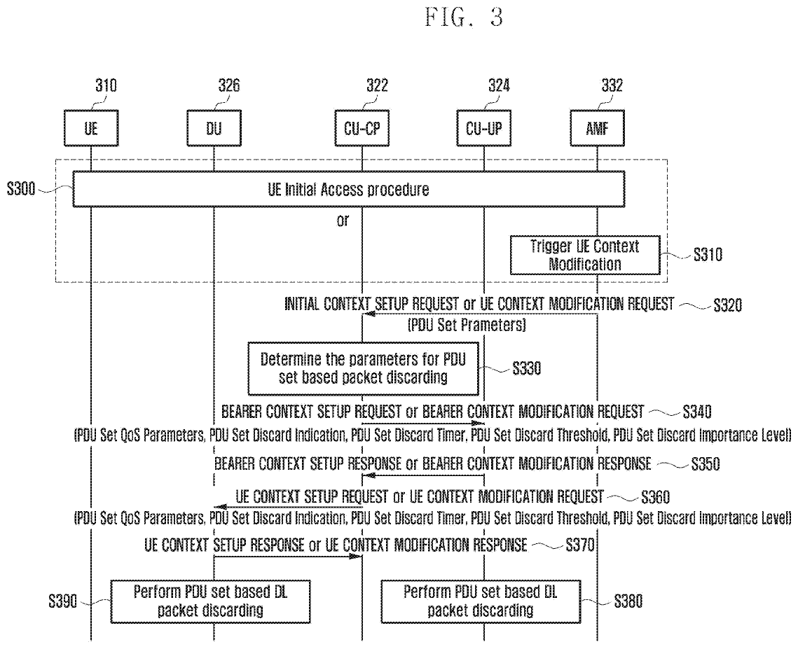

Meanwhile, FIG. 3 is a sequence diagram illustrating operations and signaling procedures of respective nodes or functions to support an operation in which packet discarding in units of a PDU set can be performed by a CU-UP and a DU of an RAN node according to an embodiment of the disclosure. The CU-CP of the RAN node may generate a parameter for packet discarding in units of a PDU set, based on PDU set QoS parameters transferred from the core network, and then transfer the parameter to the CU-UP and DU. The CU-CP may deliver the PDU set QoS parameters to a node or a function of at least one of the CU-UP or the DU, and may deliver a relevant parameter to a node or a function of at least one of the CU-UP or the DU so as to perform packet discarding in units of a PDU set.

Referring to FIG. 3, in operation S300, the UE 310 may perform a procedure for connection to an RAN node and a core network, or the UE 310 may already be in a connection state with the RAN node and the core network and may initiate (or trigger) a UE context modification procedure for changing PDU set QoS parameters in the core network, in operation S350. The start of a UE context modification procedure for changing the PDU set QoS parameters in the core network may be initiated by the SMF or another node or function in the core network, according to an embodiment.

In case that the UE 310 performs a procedure for connection to the RAN node and the core network in operation S320, an initial context setup request message may be transmitted to the RAN node from the core network, and in the case of the 5G core network, from an AMF 332. Alternatively, in the case of UE context modification, a UE context modification request message may be transmitted to the RAN node. In the split base station structure, the message may be transmitted to the CU-CP 322 of the RAN node. The initial context setup request message or UE context modification request message received from the core network may include PDU Set QoS Parameters information.

In operation S330, the RAN node or the CU-CP 322 of the RAN node having received PDU Set QoS Parameters information from the core network may determine a parameter value for performing packet discarding in units of a PDU set. Parameters for performing packet discarding in units of a PDU set may include at least one of the following parameters, and other parameters may be defined and used.
PDU Set Discard Indicator: An indicator indicating an operation of discarding in units of a PDU set
PDU Set Discard Timer: A timer configuration value representing a time period until packets (or referred to as PDUs) constituting a PDU set are discarded due to not being transmitted.
PDU Set Discard Threshold: A reference configuration value representing the number of packets (or referred to as PDUs) constituting a PDU set that are to be abandoned (or discarded), for performing discarding in units of a PDU set.
PDU Set Discard Importance Level: A PDU set importance criterion configuration value for performing discarding in units of a PDU set

In operation S340, the CU-CP 322 may transmit a bearer context setup request message or a bearer context modification request message to the CU-UP 324, and the message may include PDU set QoS parameters and information for performing packet discarding in units of a PDU set, such as a PDU Set Discard Indicator, a PDU Set Discard Timer, a PDU Set Discard Threshold, and a PDU Set Discard Importance Level, wherein at least one of the pieces of information may be included in the message.

The CU-UP 324 may, according to the received information, perform PDU set QoS parameter configuration and internal configuration for packet discarding in units of a PDU set, and then, in operation S350, the CU-UP 324 may transmit a bearer context setup response message or a bearer context modification response message to the CU-CP 322.

In operation S380, the CU-UP 324 may begin to perform operations related to packet discarding in units of a PDU set.

In operation S360, the CU-CP 322 may transmit a UE context setup request message or a UE context modification request message to the DU 326, and may include PDU set QoS parameters and information for performing packet discarding in units of a PDU set, such as a PDU Set Discard Indicator, a PDU Set Discard Timer, a PDU Set Discard Threshold, and a PDU Set Discard Importance Level, wherein at least one of the pieces of information may be included in the message.

The DU 326 may perform PDU set QoS parameter configuration and internal configuration for packet discarding in units of a PDU set, based on the information received in operation S360. In operation S370, the DU 326 may transmit a UE context setup response message or a UE context modification response message to the CU-CP 322. In operation S390, the DU 326 may begin to perform an operation related to packet discarding in units of a PDU set.

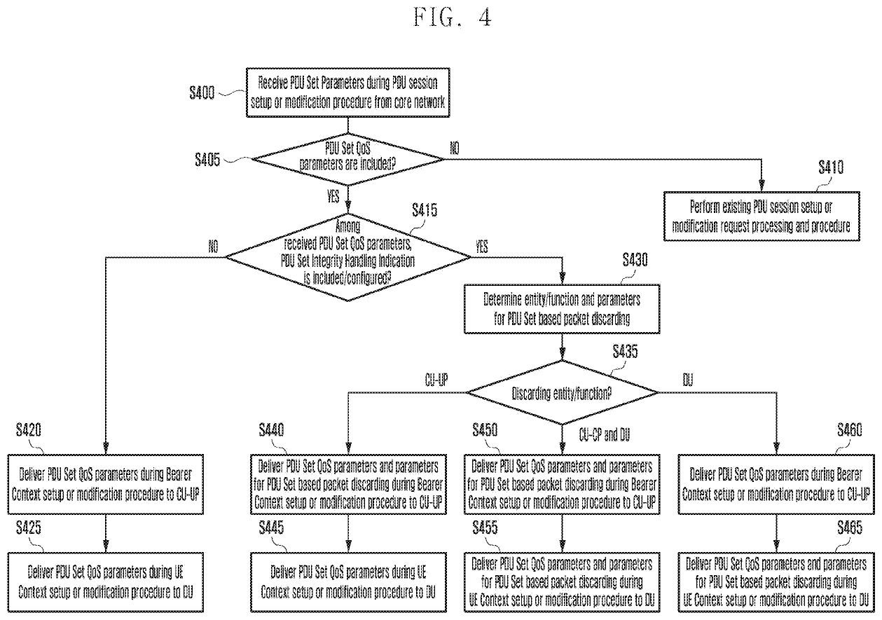

FIG. 4 is a flowchart illustrating an operation of a CU-CP in an RAN node according to an embodiment of FIG. 3. In operation S400, the CU-CP may receive a PDU session setup request or a PDU session modification request from the core network. In operation S405, the CU-CP may identify whether PDU set QoS parameters are included in the PDU session setup request or the PDU session modification request. When it is identified that the PDU set QoS parameters are not included in operation S405, the CU-CP may perform an existing PDU setup request or PDU session modification request processing and an additional procedure in operation S410. When it is identified that the PDU set QoS parameters are included in operation S405, the CU-CP may identify whether the received PDU Set QoS Parameters information includes a PDU set integrity handling indication (PSIHI) and whether it is configured to operate accordingly, in operation S415.

When the PDU set integrity handling indication (PSIHI) is not included or not configured to operate in operation S415, the CU-CP may transmit a bearer context setup request message or a bearer context modification request message to the CU-UP, including the PDU set QoS parameters, in operation S420. The PDU set QoS parameters may be included on a DRB basis or on a QoS flow basis, or may be included on both bases. When PDU Set QoS parameters are included on a DRB basis, the CU-CP may, upon generating the DRB, calculate PDU set QoS parameters for each DRB, based on PDU set QoS parameter values received from the core network on a QoS flow basis with respect to the QoS flows included in the DRB, and may include the calculated parameters. In operation S425, the CU-CP may deliver the PDU set QoS parameters to the DU while performing a UE context setup request procedure or a UE context modification request procedure. The PDU set QoS parameters may be included on a DRB basis or on a QoS flow basis, or may be included on both bases. When PDU set QoS parameters are included on a DRB basis, the CU-CP may, upon generating the DRB, calculate PDU set QoS parameters for each DRB, based on PDU set QoS parameter values received from the core network on a QoS flow basis with respect to the QoS flows included in the DRB, and may include the calculated parameters.

When, in operation S415, the PDU set integrity handling indication (PSIHI) is not included or is not configured to operate, the CU-CP may determine an entity or function for discarding packets in units of a PDU set and may determine parameter values for discarding packets in in units of a PDU set, in operation S430.

In operation S435, when the CU-UP has determined to perform packet discarding in units of a PDU set depending on the determined entity or function for discarding packets in units of a PDU set, the CU-CP may deliver the parameter values required for performing packet discarding in units of a PDU set and the PDU set QoS parameters to the CU-UP while performing a bearer context setup or modification procedure with the CU-UP, in operation S440. The PDU set QoS parameters and the parameter values required for performing packet discarding in units of a PDU set may be included on a DRB basis or on a QoS flow basis, or may be included on both bases. When the PDU Set QoS parameters or the parameter values required for performing packet discarding in units of a PDU set are included on a DRB basis, the CU-CP may, upon generating the DRB, calculate the PDU set QoS parameters for each DRB and the parameter values required for performing packet discarding in units of a PDU set, based on PDU set QoS parameter values received from the core network on a QoS flow basis with respect to the QoS flows included in the DRB, and may include the calculated parameters and parameter values. In operation S445, the CU-CP may deliver the PDU set QoS parameters to the DU while performing a UE context setup request procedure or a UE context modification request procedure. The PDU set QoS parameters may be included on a DRB basis or on a QoS flow basis, or may be included on both bases. When PDU set QoS parameters are included on a DRB basis, the CU-CP may, upon generating the DRB, calculate PDU set QoS parameters for each DRB, based on PDU set QoS parameter values received from the core network on a QoS flow basis with respect to the QoS flows included in the DRB, and may include the calculated parameters.

In operation S435, when the CU-UP and the DU have determined to perform packet discarding in units of a PDU set depending on the determined entity or function for discarding packets in units of a PDU set, the CU-CP may deliver the parameter values required for performing packet discarding in units of a PDU set and the PDU set QoS parameters to the CU-UP while performing a bearer context setup or modification procedure, in operation S450. The PDU set QoS parameters and the parameter values required for performing packet discarding in units of a PDU set may be included on a DRB basis or on a QoS flow basis, or may be included on both bases. When the PDU Set QoS parameters or the parameter values required for performing packet discarding in units of a PDU set are included on a DRB basis, the CU-CP may, upon generating the DRB, calculate the PDU set QoS parameters for each DRB and the parameter values required for performing packet discarding in units of a PDU set, based on PDU set QoS parameter values received from the core network on a QoS flow basis with respect to the QoS flows included in the DRB, and may include the calculated parameters and parameter values. In operation S455, the CU-CP may deliver the parameter values required for performing packet discarding in units of a PDU set and the PDU set QoS parameters to the DU while performing a UE context setup request procedure or a UE context modification request procedure. The PDU set QoS parameters and the parameter values required for performing packet discarding in units of a PDU set may be included on a DRB basis or on a QoS flow basis, or may be included on both bases. When PDU set QoS parameters or the parameter values required for performing packet discarding in units of a PDU set are included on a DRB basis, the CU-CP may, upon generating the DRB, calculate the PDU set QoS parameters for each DRB and the parameter values required for performing packet discarding in units of a PDU set, based on PDU set QoS parameter values received from the core network on a QoS flow basis with respect to the QoS flows included in the DRB, and may include the calculated parameters and parameter values.

In operation S435, when the DU has determined to perform packet discarding in units of a PDU set depending on the determined entity or function for discarding packets in units of a PDU set, the CU-CP may deliver the PDU set QoS parameter values to the CU-UP while performing a bearer context setup or modification procedure, in operation S460. The PDU set QoS parameter values may be included on a DRB basis or on a QoS flow basis, or may be included on both bases. When the PDU Set QoS parameters or the parameter values required for performing packet discarding in units of a PDU set are included on a DRB basis, the CU-CP may, upon generating the DRB, calculate the PDU set QoS parameter values for each DRB, based on PDU set QoS parameter values received from the core network on a QoS flow basis with respect to the QoS flows included in the DRB, and may include the calculated parameter values. In operation S465, the CU-CP may deliver the parameter values required for performing packet discarding in units of a PDU set and the PDU set QoS parameters to the DU while performing a UE context setup request procedure or a UE context modification request procedure. The PDU set QoS parameters and the parameter values required for performing packet discarding in units of a PDU set may be included on a DRB basis or on a QoS flow basis, or may be included on both bases. When PDU set QoS parameters or the parameter values required for performing packet discarding in units of a PDU set are included on a DRB basis, the CU-CP may, upon generating the DRB, calculate the PDU set QoS parameters for each DRB and the parameter values required for performing packet discarding in units of a PDU set, based on PDU set QoS parameter values received from the core network on a QoS flow basis with respect to the QoS flows included in the DRB, and may include the calculated parameters and parameter values.

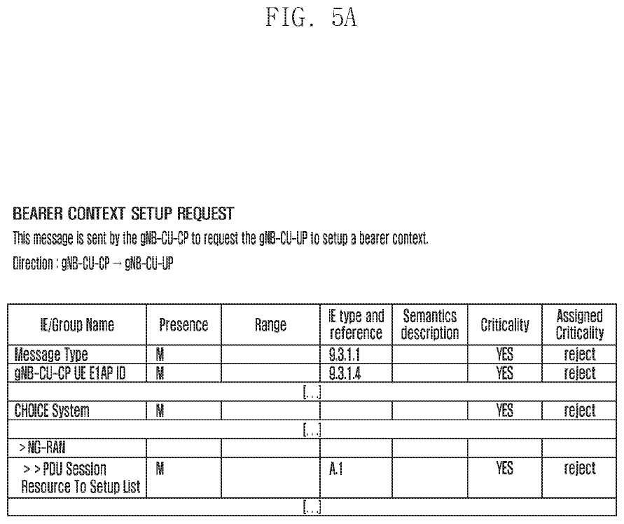

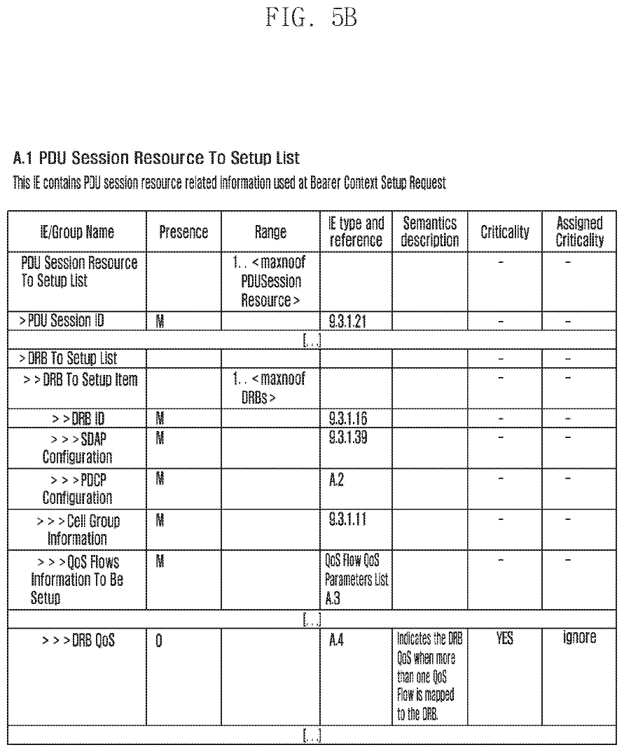

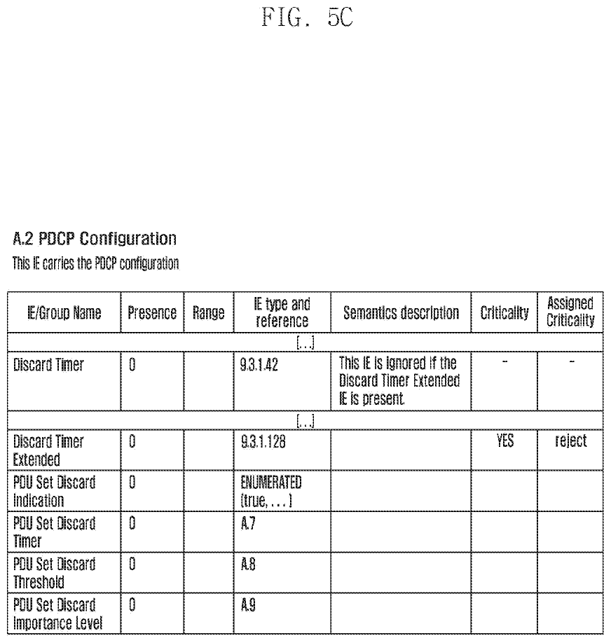

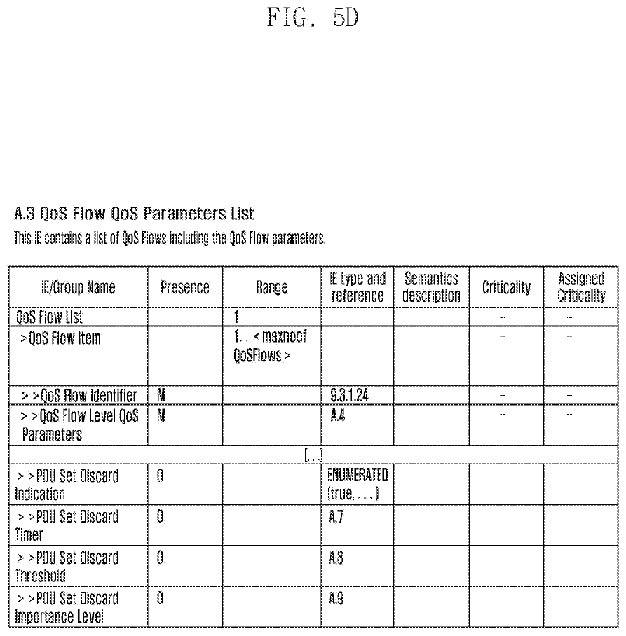

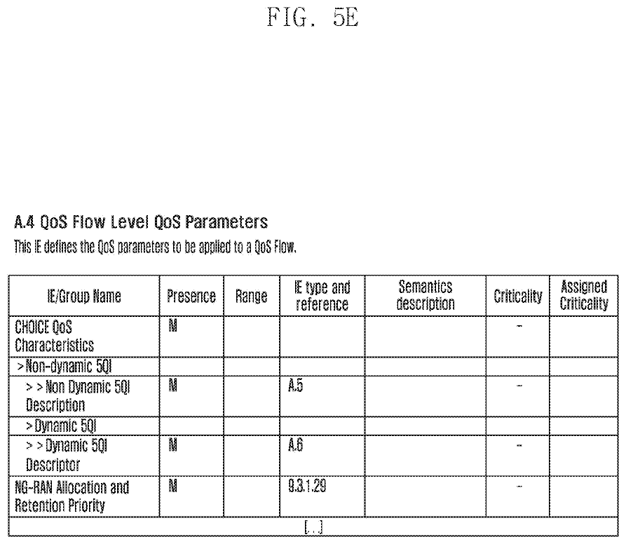

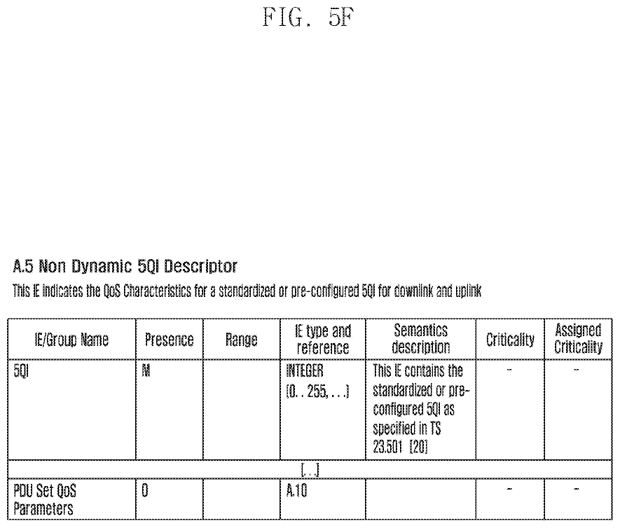

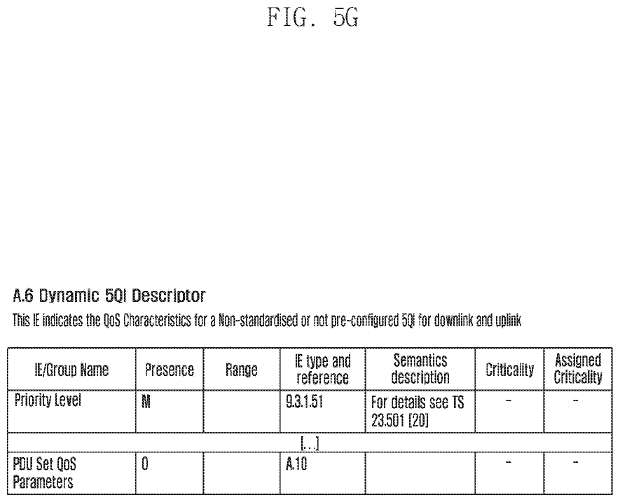

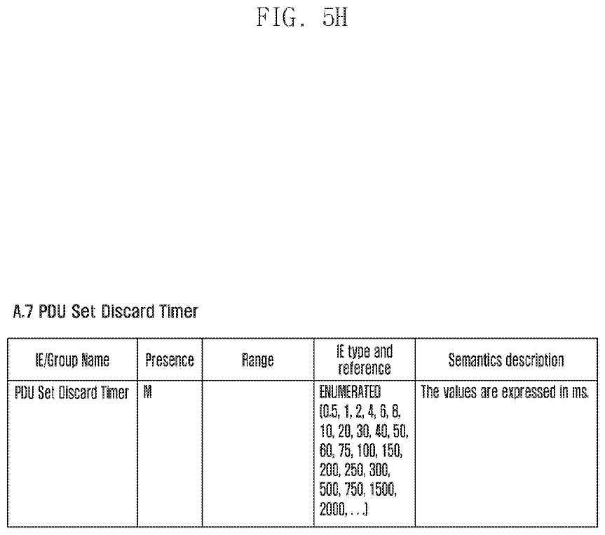

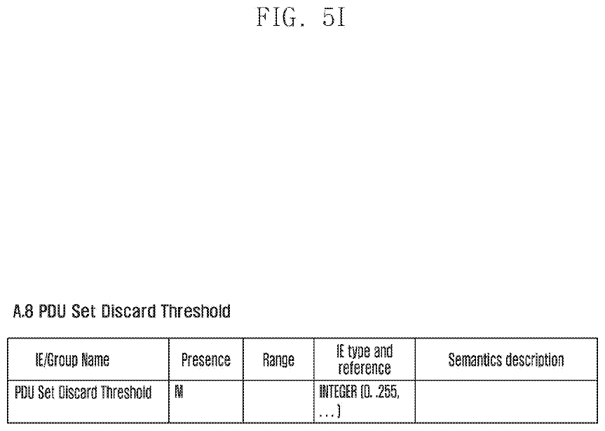

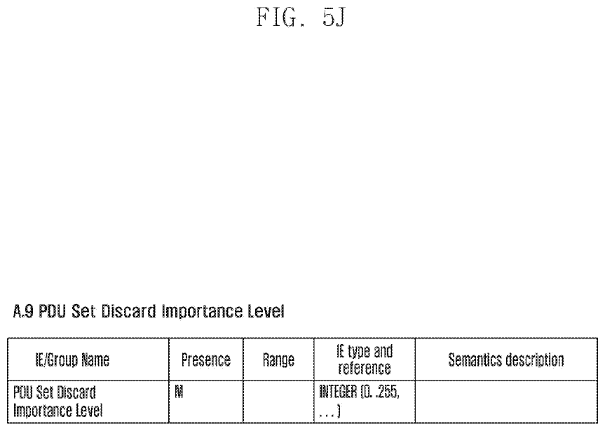

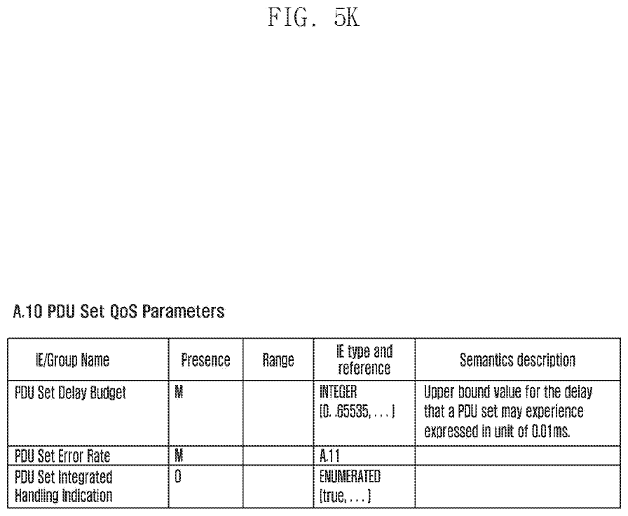

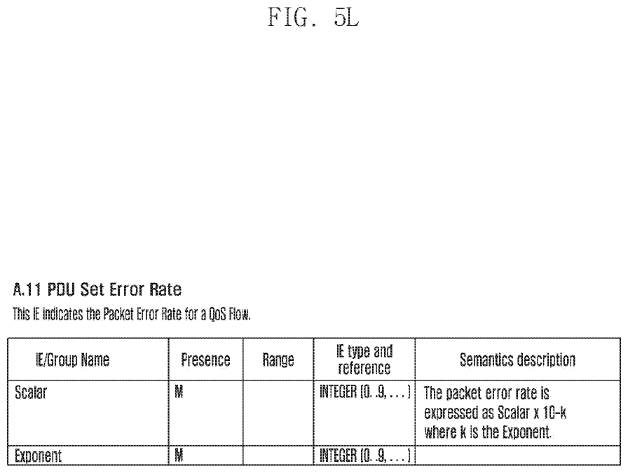

Meanwhile, FIGS. 5A to 5L illustrate a configuration example of a BEARER CONTEXT SETUP REQUEST message used for an E1 interface and used in operation S340 of FIG. 3, to send a request for setup of a bearer context to a CU-UP from a CU-CP in an RAN node.

The names of information elements (IEs) in FIGS. 5A to 5L are one example, and may be defined by other names having the same function, or the values included in the IE may also be defined and used differently. In addition, some information of the (IEs) included in FIGS. 5A to 5L may be used by defining existing other messages or new messages used for the E1 interface and adding the same. FIGS. 5A to 5L illustrate information used for the embodiment shown in FIG. 3, while other IE information less relevant to the embodiment of FIG. 3 has been omitted.

FIG. 5A illustrates a configuration example of a BEARER CONTEXT SETUP REQUEST message. The BEARER CONTEXT SETUP REQUEST message may include a message type IE used to distinguish existing E1 application protocol (E1AP) message types and a gNB-CU-CP UE E1AP ID IE used to identify a UE in an E1 interface. In addition, a PDU Session Resource to Setup List IE for configuring a UE service may be included.

FIG. 5B illustrates a configuration example of a PDU Session Resource to Setup List IE included in a BEARER CONTEXT SETUP REQUEST message. The PDU Session Resource to Setup List IE may include a PDCP configuration IE, a QoS Flows Information To Be Setup IE, and a DRB QOS IE for each DRB to be configured.

FIG. 5C illustrates a configuration example of a PDCP Configuration IE included in a PDU Session Resource to Setup List IE. In addition to the existing IE information, the PDCP Configuration IE may include information of parameters required to perform packet discarding in units of a PDU set, for example, information such as a PDU Set Discard Indicator IE, a PDU Set Discard Timer IE, a PDU Set Discard Threshold IE, and a PDU Set Discard Importance Level IE. The PDU Set Discard Indicator IE is used as an indicator for indicating a discard operation in units of a PDU set, and when included, may include information for indicating the operation, such as “true”. The PDU Set Discard Timer IE indicates the value of a timer for configuring a time during which packets (or referred to as PDUs) configuring a PDU set are not transmitted and then discarded, and an example of the PDU Set Discard Timer IE configuration is illustrated in FIG. 5H. The PDU Set Discard Threshold IE indicates a configuration value of a reference number of packets (or referred to as PDUs) constituting a PDU set, which are to be abandoned (or discarded), for performing discarding in units of a PDU set. FIG. 5I illustrates an example of the configuration of a PDU Set Discard Threshold IE. The PDU Set Discard Importance Level IE indicates a configuration value of a PDU set importance criterion for performing PDU set discard in units of a PDU set. FIG. 5J illustrates a configuration example of a PDU Set Discard Importance Level IE.

FIG. 5D illustrates a configuration example of a QoS Flow QoS Parameters List IE corresponding to a QoS Flows Information To Be Setup IE included in a PDU Session Resource to Setup List IE. The QoS flow QoS parameters list IE may include QoS flow identifier IE information, which is used to distinguish each QoS flow, and QoS Flow Level QoS Parameters IE information for each QoS flow, and may include information such as a PDU Set Discard Indicator IE, a PDU Set Discard Timer IE, a PDU Set Discard Threshold IE, and a PDU Set Discard Importance Level IE as information required to perform packet discarding in units of a PDU set.

FIG. 5E illustrates a configuration example of a QoS flow QoS parameters IE included in a QoS flow QoS parameters list IE. The QoS flow QoS parameters IE may include Non Dynamic 5QI Descriptor IE information or Dynamic 5QI Descriptor IE information.

FIG. 5E illustrates a configuration example of a non-Dynamic 5QI Descriptor IE included in a QoS flow QoS parameters IE. In addition to existing information, PDU Set QoS Parameters information may be included in the Non Dynamic 5QI Descriptor IE.

FIG. 5F illustrates a configuration example of a Dynamic 5QI Descriptor IE included in a QoS flow QoS parameters IE. In addition to existing information, PDU Set QoS Parameters information may be included in the Dynamic 5QI Descriptor IE.

FIG. 5K illustrates a configuration example of a PDU Set QoS Parameters IE included in a Non Dynamic 5QI Descriptor IE or a Dynamic 5QI Descriptor IE. The PDU Set QoS Parameters IE may include PDU Set Delay Budget IE, PDU Set Error Rate IE, and PDU Set Integrated Handling Indication IE information. The PDU Set Delay Budget IE indicates an upper bound of a delay during packet transmission in units of a PDU set between a UE and a UPF. For example, the PDU Set Delay Budget IE may indicate a delay time from a time point at which the first packet of a PDU set is received to a time point at which all packets of the same PDU set are received. The PDU Set Error Rate IE indicates an upper bound on a loss in units of a PDU set in a non-congestion state in which no congestion has occurred in the network. FIG. 5L illustrates a configuration example of a PDU Set Error Rate IE. The PDU set error rate value may be configured with a scalar value and an exponent value, and may be configured by a different method such as an integer. The PDU Set Integrated Handling Indication IE indicates an indicator indicating that all packets belonging to the PDU set should be successfully transmitted in order for the packets included in the PDU set to be used.

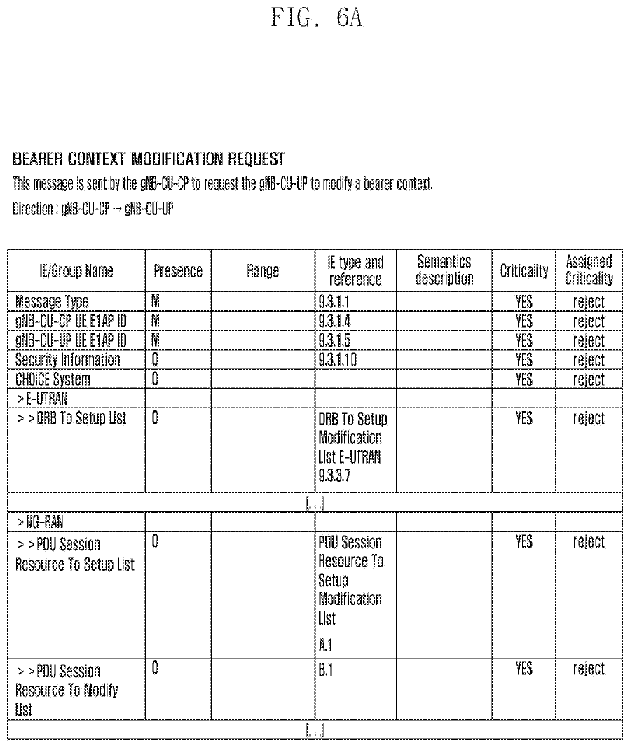

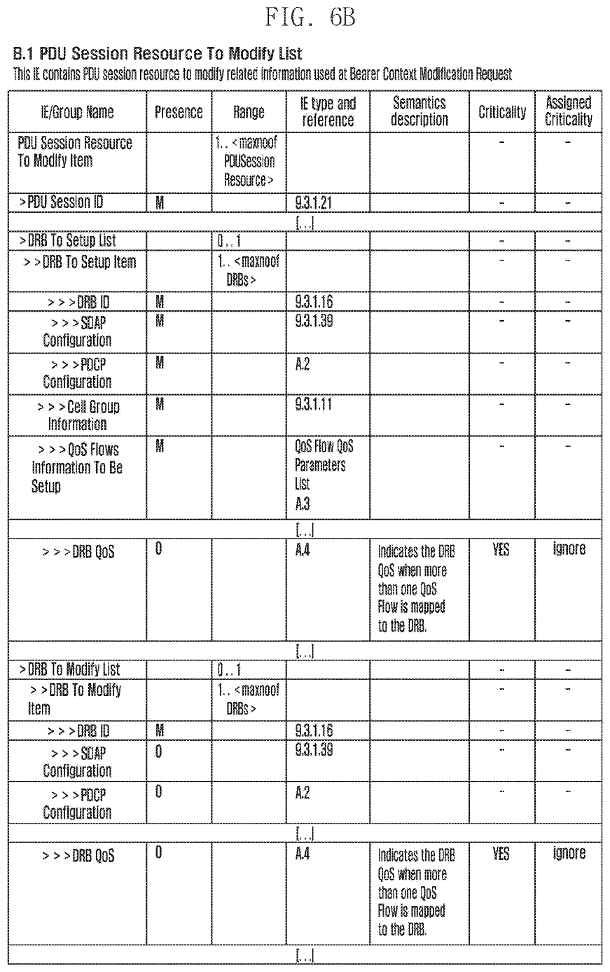

Meanwhile, FIG. 6A and FIG. 6B illustrate a configuration example of a BEARER CONTEXT MODIFICATION REQUEST message, which is used for an E1 interface and used in operation S340 of FIG. 3, to send a request for modification of a bearer context to a CU-UP from a CU-CP in an RAN node. The IE names in FIGS. 6A and 6B may be defined by other names having the same function, or the values included in the IEs may be defined and used differently. In addition, part of the information of the information elements (IEs) included in FIG. 6A and FIG. 6B may be used by defining a new message or an existing other message used for the E1 interface and adding the same. FIG. 6 illustrates information used for the embodiment of FIG. 3, and other IE information which is less related to the embodiment of FIG. 3 is omitted.

FIG. 6A illustrates a configuration example of a BEARER CONTEXT MODIFICATION REQUEST message. The BEARER CONTEXT MODIFICATION REQUEST message may include a Message Type IE used to distinguish the existing E1 application protocol (EIAP) message types and a gNB-CU-CP UE E1AP ID IE used to distinguish a UE on the E1 interface. In addition, the PDU Session Resource to Setup List IE and PDU Session Resource to Modify List IE information to be configured for a UE service may be included. The PDU Session Resource to Setup List IE follows the configuration example described in FIG. 5B above and the description of FIGS. 5A to 5L above.

FIG. 6B illustrates a configuration example of a PDU Session Resource to Modify List IE included in a BEARER CONTEXT MODIFICATION REQUEST message. The PDU Session Resource to Modify List IE may include a PDCP Configuration IE, a QoS Flows Information To Be Setup IE, and a DRB QOS IE for each DRB to be configured, and may include a PDCP Configuration IE which is required to be changed and a DRB QoS IE which is required to be changed for each DRB to be changed. The PDCP configuration IE included in the PDU Session Resource to Modify List IE follows the configuration example described in FIG. 5C above and the description of FIGS. 5A to 5L above. The QoS Flows Information To Be Setup IE included in the PDU Session Resource to Modify List IE follows the configuration examples of the QoS Flow QoS Parameters List IE described in FIG. 5D and the description in FIGS. 5A to 5L above. The DRB QOS IE included in the PDU Session Resource to Modify List IE follows the configuration example described in the QoS Flow QoS Parameters IE of FIG. SE and the descriptions of FIGS. 5A to 5L above.

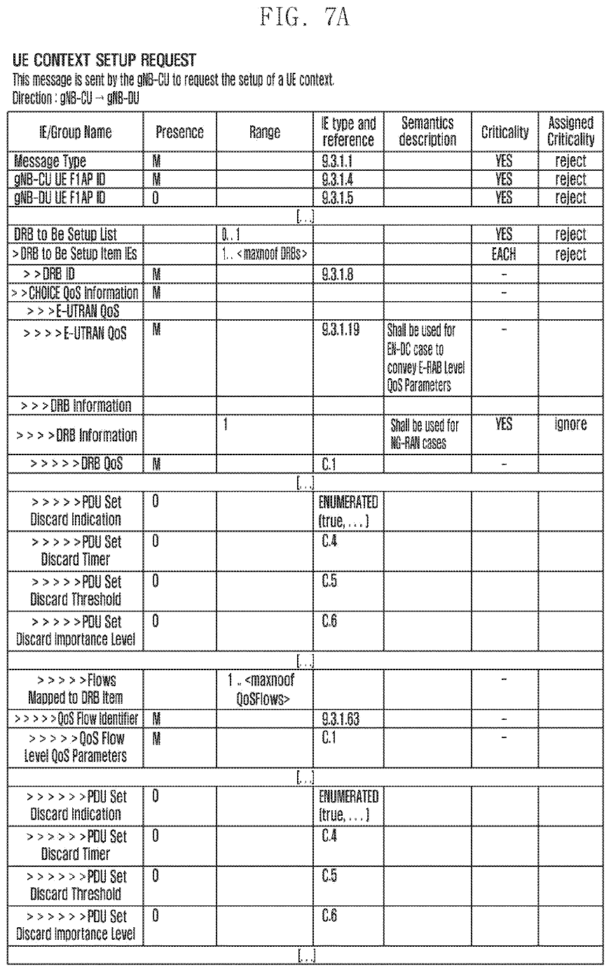

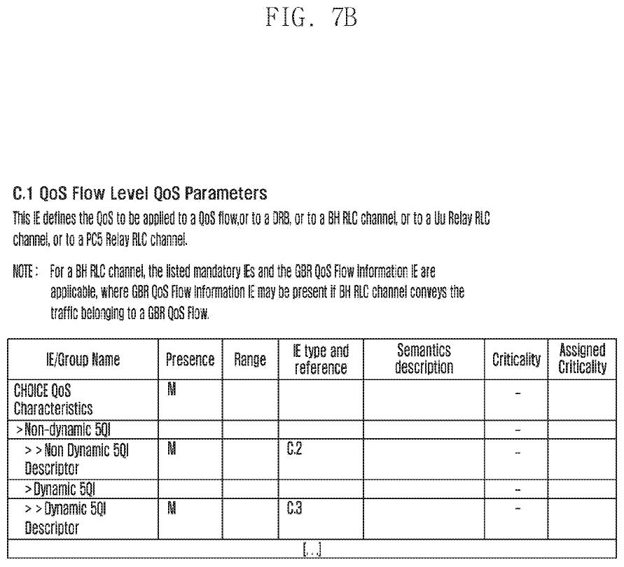

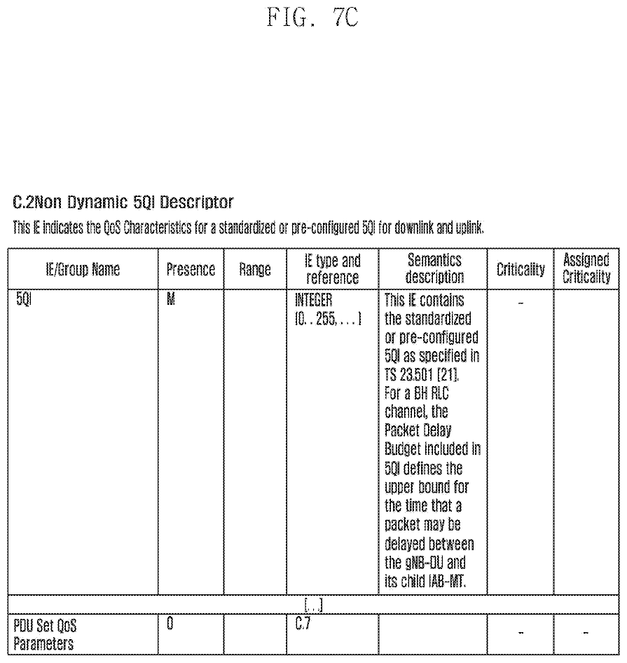

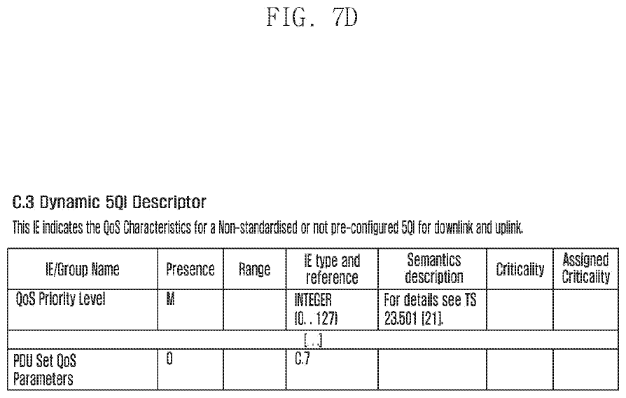

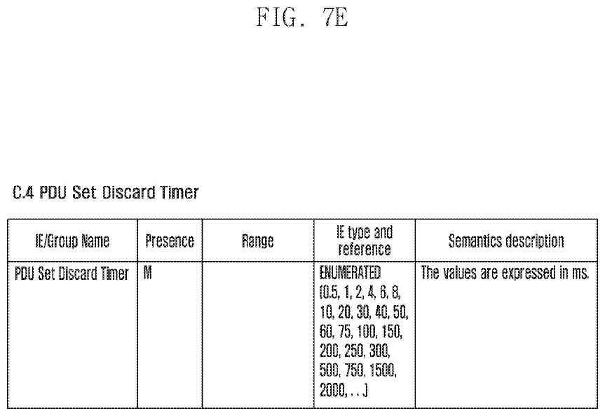

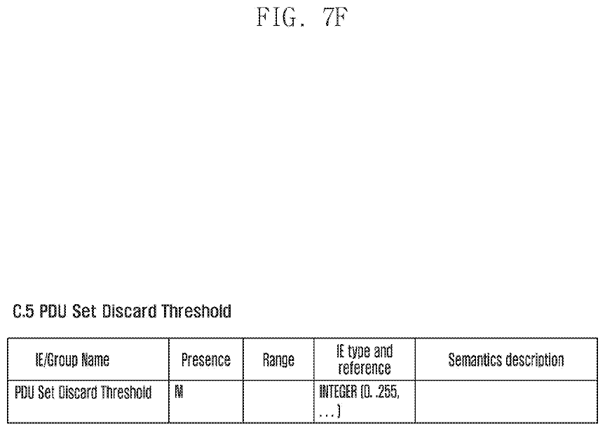

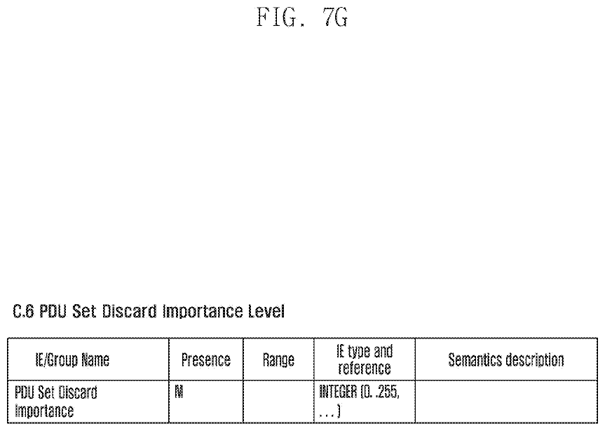

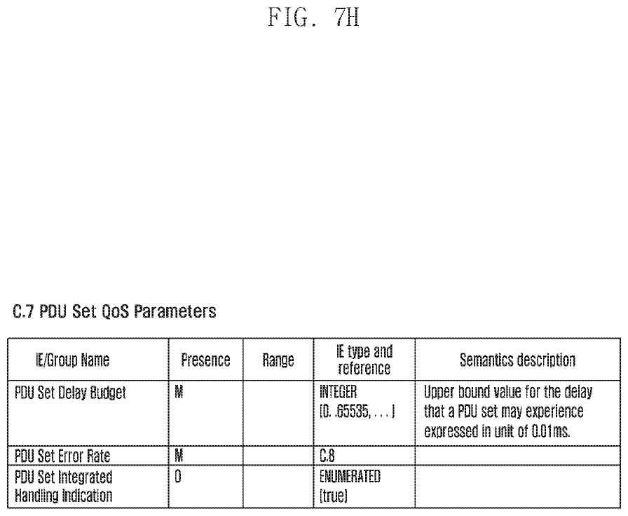

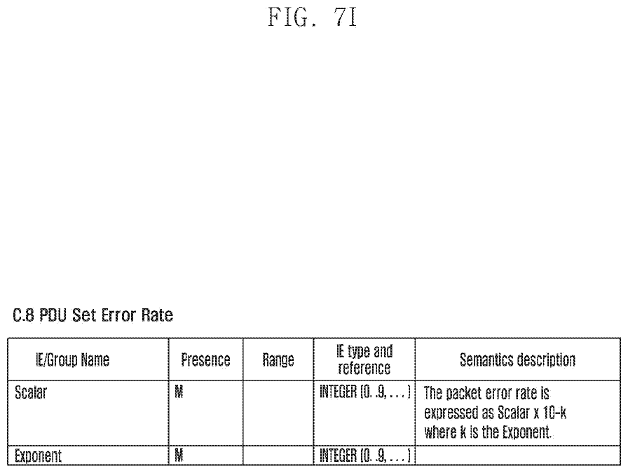

FIGS. 7A to 7I illustrate a configuration example of a UE CONTEXT SETUP REQUEST message, which is used for an F1 or WI interface and used in operation S360 of FIG. 3, to send a request for setup of a UE context to a DU from a CU-CP in an RAN node. The IE names in FIGS. 7A to 7I are one example, and may be defined by other names having the same function or the values included in the IE may be defined and used differently. In addition, a part of the information of the information element (IE) included in FIGS. 7A to 7I may be used by defining an existing other message or a new message used for the E1 interface and adding the same. In FIGS. 7A to 7I, information used for the embodiment of FIG. 3 is illustrated, and other IE information which is less related to the embodiment of FIG. 3 is omitted.

FIG. 7A illustrates a configuration example of a UE CONTEXT SETUP REQUEST message. The UE CONTEXT SETUP REQUEST message may include a message type IE used to distinguish existing F1 application protocol (FIAP) or WIAP message types, a gNB-CU-CP UE F1AP ID IE used to identify a UE in the F1 or W1 interface, and the like. In addition, the UE CONTEXT SETUP REQUEST message may include a DRB to Be Setup List IE to be configured for a UE service. The DRB to be Setup List IE may include information for each DRB to be configured, and may include configuration information for each QoS flow supported by one DRB. The DRB-specific information may include DRB QoS IE information and information such as parameters required to perform packet discarding in units of a PDU set. Configuration information for each QoS flow supported by one DRB may include a QoS flow identifier IE information, which is used for identifying a QoS flow, and QoS Flow Level QoS Parameters IE information for each QoS flow, and may include parameters information required for discarding packets in units of a PDU set.

The parameters information required to perform packet discarding in units of a PDU set may include, for example, information such as a PDU Set Discard Indicator IE, a PDU Set Discard Timer IE, a PDU Set Discard Threshold IE, and a PDU Set Discard Importance Level IE. The PDU Set Discard Indicator IE is used as an indicator for indicating a discard operation in units of a PDU set, and when included, may include information for indicating the operation, such as “true”. The PDU Set Discard Timer IE indicates a timer configuration value representing a time period until the packets (or referred to as PDUs) constituting the PDU set are discarded due to not being transmitted, and FIG. 7E illustrates an example of the configuration of the PDU Set Discard Timer IE. The PDU Set Discard Threshold IE indicates a reference configuration value representing the number of packets (or referred to as PDUs) constituting a PDU set that are to be abandoned (or discarded), for performing discarding in units of a PDU set. FIG. 7F illustrates a configuration of an example of a PDU Set Discard Threshold IE. The PDU Set Discard Importance Level IE indicates importance criterion configuration value of a PDU set for performing discarding in units of a PDU set, and FIG. 7G illustrates a configuration example of the PDU Set Discard Importance Level IE.

FIG. 7B illustrates a configuration example of a QoS Flow Level QoS Parameters IE that may indicate DRB QoS IE and QoS Flow Level QoS Parameters IE information included in a UE context setup request message. The QoS Flow Level QoS Parameters IE may include Non Dynamic 5QI Descriptor IE information or Dynamic 5QI Descriptor IE information.

FIG. 7C illustrates a configuration example of a Non Dynamic SQI Descriptor IE included in a QoS Flow Level QoS Parameters IE, In addition to the existing information, the Non Dynamic 5QI Descriptor IE may include PDU Set QoS Parameters information.

FIG. 7D illustrates a configuration example of a Dynamic 5QI Descriptor IE included in a QoS Flow Level QoS Parameters IE. In addition to existing information, the Dynamic 5QI Descriptor IE may include PDU Set QoS Parameters information.

FIG. 7H illustrates a configuration example of a PDU Set QoS Parameters IE included in a Non Dynamic 5QI Descriptor IE or a Dynamic 5QI Descriptor IE. The PDU Set QoS Parameters IE may include PDU Set Delay Budget IE, PDU Set Error Rate IE, and PDU Set Integrated Handling Indication IE information. The PDU Set Delay Budget IE indicates an upper bound of a delay during packet transmission in units of a PDU set between a UE and a UPF. For example, the PDU Set Delay Budget IE may indicate a delay time from a time point at which the first packet of the PDU set is received to a time point at which all packets of the same PDU set are received. The PDU Set Error Rate IE indicates an upper bound on a loss in units of a PDU set in a non-congestion state in which no congestion has occurred in the network. FIG. 7I illustrates a configuration example of a PDU Set Error Rate IE. The PDU Set Error Rate IE indicates a PDU set error rate value, which may be configured with a scalar value and an exponent value, and may also be configured by another method such as an integer. The PDU Set Integrated Handling Indication IE indicates an indicator indicating that all packets belonging to the PDU set should be successfully transmitted in order for the packets included in the PDU set to be used.

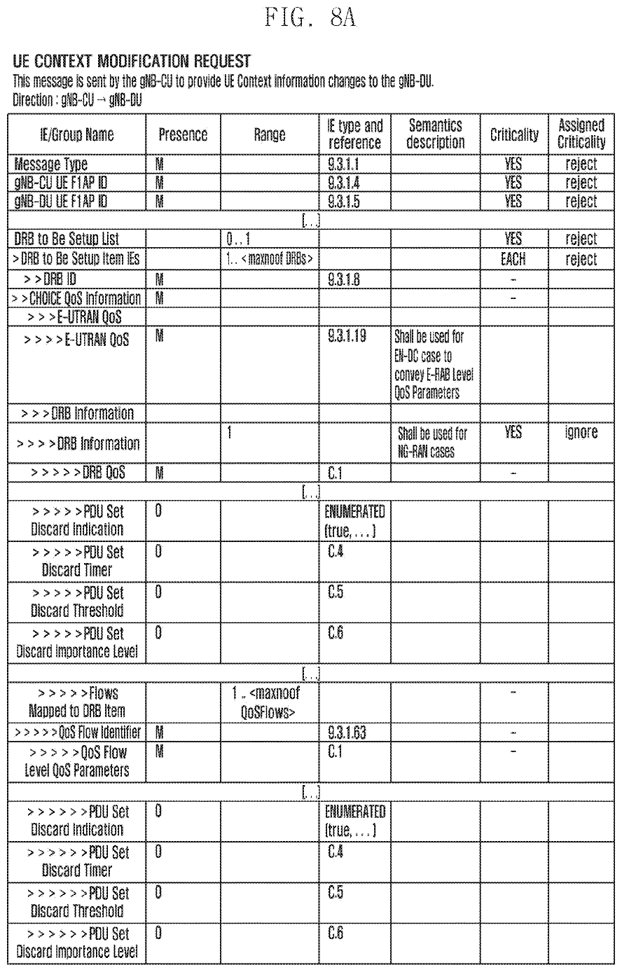

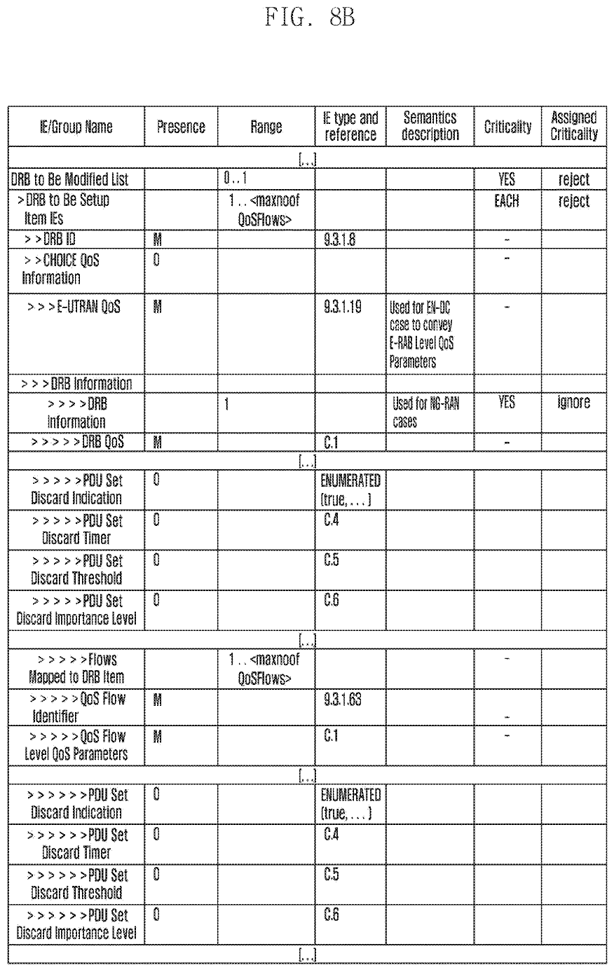

Meanwhile, FIG. 8A and FIG. 8B illustrate a configuration example of a UE CONTEXT MODIFICATION REQUEST message, which is used for an F1 or W1 interface and used in operation S360 of FIG. 3, to send a request for modification of a UE context (bearer context) to a DU from a CU-CP in an RAN node. The IE names of FIG. 8A and FIG. 8B are an example, and may be defined by other names having the same function or the values included in the IE may be defined and used differently. In addition, some information of the (IEs) included in FIGS. 8A and 8B may be used by defining existing other messages or new messages used for the F1 or W1 interface and adding the same. In FIG. 8A and FIG. 8B, information used for the embodiment of FIG. 3 is shown, and other IE information which is less related to the embodiment of FIG. 3 is omitted.

FIG. 8A and FIG. 8B illustrate a configuration example of a UE CONTEXT MODIFICATION REQUEST message. The UE CONTEXT MODIFICATION REQUEST message may include a message type IE used to distinguish an existing F1 application protocol (F1AP) or W1AP message types, and a gNB-CU-CP UE F1AP ID IE used to identify a UE on the F1 or W1 interface. A DRB to Be Setup List IE to be configured for a UE service may be included. The DRB to Be Setup List IE may include information for each DRB to be configured, and may include configuration information for each QoS flow supported by one DRB. In addition, a DRB to Be Modified List IE that is required to be changed for a UE service may be included. The DRB to Be Modified List IE may include information for each DRB to be modified, and may include information for each QoS flow supported by one DRB. The DRB-specific information may include information such as DRB QOS IE information and parameters required to perform packet discarding in units of a PDU set, and the DRB QoS IE information follows the description of the configuration example in the QoS Flow Level QoS Parameters IE in FIG. 7B and the description in FIGS. 7A to 7I given above. The configuration information for each QoS flow supported by one DRB may include a QoS Flow Identifier IE information and a QoS Flow Level QoS Parameters IE information for distinguishing the QoS flows for each QoS flow, and may include parameters information required to perform packet discarding in units of a PDU set. The QoS Flow Level QoS Parameters IE information follows the above-described configuration example of the QoS Flow Level QoS Parameters IE in FIG. 7B and the above-described description of FIGS. 7A to 7I.

The parameters information required to perform packet discarding in units of a PDU set may include, for example, information such as a PDU Set Discard Indicator IE, a PDU Set Discard Timer IE, a PDU Set Discard Threshold IE, and a PDU Set Discard Importance Level IE. The PDU Set Discard Indicator IE is used as an indicator for indicating a discard operation in units of a PDU set, and when included, may include information for indicating the operation, such as “true”. The PDU Set Discard Timer IE indicates a timer configuration value representing a time period until the packets (or referred to as PDUs) constituting the PDU set are discarded due to not being transmitted, and FIG. 7E illustrates an example of the configuration of the PDU Set Discard Timer IE. The PDU Set Discard Threshold IE indicates a reference configuration value representing the number of packets (or referred to as PDUs) constituting a PDU set that are to be abandoned (or discarded), for performing discarding in units of a PDU set. FIG. 7F illustrates a configuration of an example of a PDU Set Discard Threshold IE. The PDU Set Discard Importance Level IE indicates importance criterion configuration value of a PDU set for performing discarding in units of a PDU set, and FIG. 7G illustrates a configuration example of the PDU Set Discard Importance Level IE.

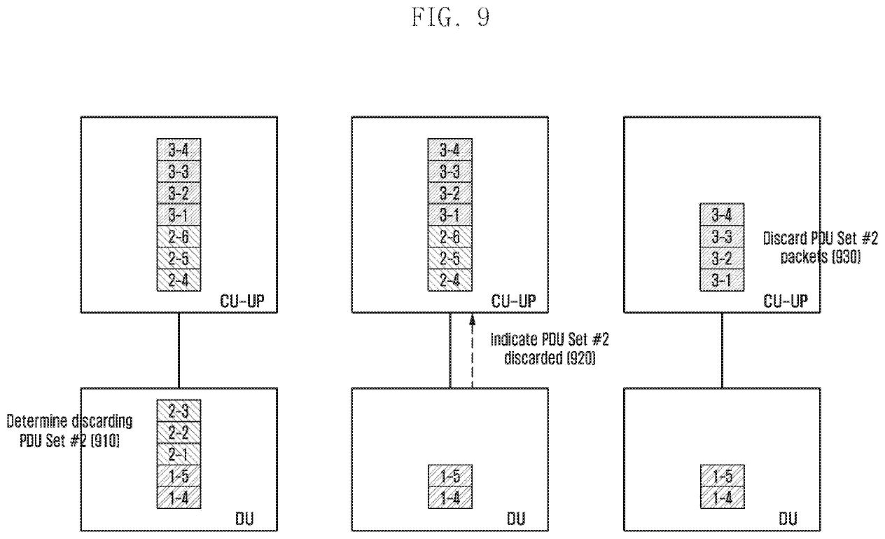

FIG. 9 illustrates an operation for performing packet discarding in units of a PDU set in a CU-UP and a DU of an RAN node according to an embodiment of the disclosure. FIG. 9 illustrates a series of procedures in which, when a packet belonging to one PDU set is discarded in a DU, packets belonging to the same PDU set stored in the DU are discarded, and information regarding the PDU set being discarded is transferred to a CU-UP, so that the packets belonging to the PDU set are discarded in the CU-UP.

In operation 910 of FIG. 9, the DU may determine to discard packets belonging to PDU set #2, and may discard the packets belonging to PDU set #2. In operation 920, the DU may deliver, to the CU-UP, information indicating that PDU set #2 has been discarded. The information of PDU set discarded in operation 920 may be transferred to the CU-UP by using a packet transferred through a user plane of the F1-U or W1-U interface between the CU-UP and the DU, or may be transferred to the CU-UP as an E1AP signaling message transferred through a control plane of the E1 interface after being transferred to the CU-CP as an FIAP or WIAP signaling message transferred through a control plane of the F1-C or W1-C interface. The CU-UP, upon receiving discard information of PDU set #2 from the DU in operation 920, may discard the stored packets belonging to PDU set #2 and may also discard packets belonging to PDU set #2 subsequently delivered from the UPF in operation 930.

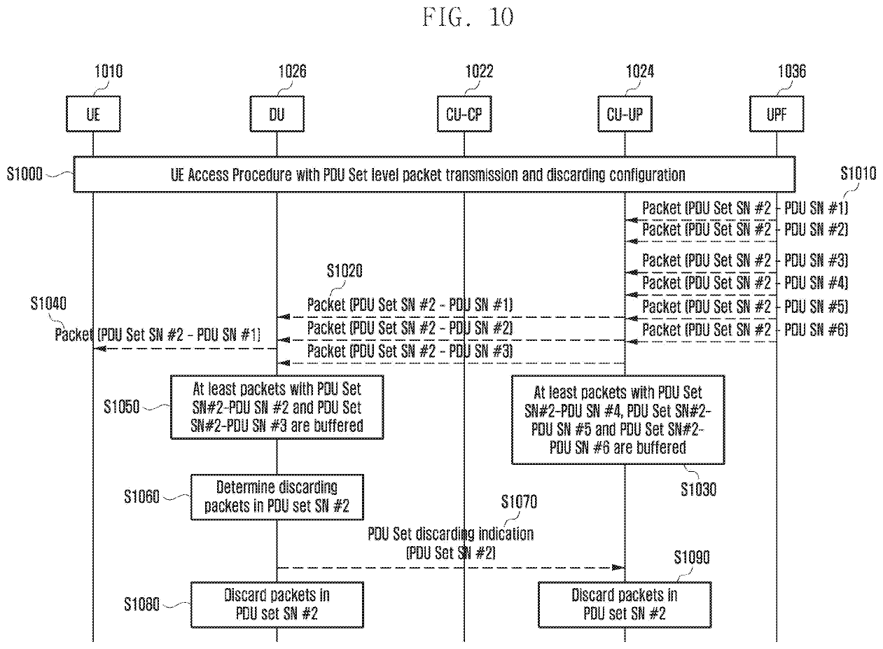

FIG. 10 is a sequence diagram illustrating an operation for performing packet discarding in units of a PDU set in a CU-UP and a DU of an RAN node according to an embodiment of the disclosure. Specifically, FIG. 10 illustrates, in a case in which a DU discards packets belonging to one PDU set, operations and signaling procedures of each node or function for discarding packets belonging to the same PDU set stored in the DU, and for transmitting information on the discarded PDU set to the CU-UP so as to support the CU-UP in performing an operation of discarding packets belonging to the corresponding PDU set.

Referring to FIG. 10, in operation S1000, a UE 1010 performs a procedure for connection to an RAN node and a core network. In this case, a configuration for packet transmission in units of a PDU set and for discarding packets in units of a PDU set may be configured for the UE 1010, a UPF 1036, and a CU-CP 1022, the CU-UP 1024, and the DU 1026 of the RAN node. In operation S1010, the UPF 1036 may transmit, for example, packets having a PDU set number (#) configured as 2, and may transmit six packets having sequence numbers 1 to 6 corresponding to packets belonging to PDU set #2, to the CU-UP 1024 of the RAN node. The CU-UP 1024 may store packets that have been received from the UPF 1036, and may then perform a series of processes (e.g., packet processing operations on a PDCP layer) and may then transfer the packets to the DU 1026. In the embodiment of FIG. 10, the CU-UP 1024 may transmit, to the DU 1026, packets having sequence numbers 1 to 3 among the 6 packets belonging to PDU set #2 received from the UPF 1036 in operation S1020, and may store packets having sequence numbers 4 to 6 belonging to PDU set #2 for transmission to the DU 1026 in operation S1030. The sequence number of a packet belonging to PDU set #2 transmitted from the CU-UP 1024 to the DU 1026 in operation S1020 may be the same as the sequence number of the PDU used when the UPF 1036 transmits to the CU-UP 1024, or may be used with a different sequence number configured by the CU-UP 1024 again. In the embodiment of FIG. 10, the same reference numerals are used to indicate the same or like elements for the sake of clarity. The DU 1026, having received the packets belonging to PDU set #2 from the CU-UP 1024, may transmit the packets to the UE 1010 in operation S1040. In operation S1040, only the packet with sequence number 1 among the packets of PDU set #2 transferred from the CU-UP 24 has been transmitted, and in operation S1050, the DU 1026 may store the remaining packets of PDU set #2 (e.g., packets with sequence numbers 2 and 3) for transmission to the UE 1010.

In operation S1060, the DU 1026 may determine to discard the packets belonging to PDU set #2 stored. In operation S1070, the DU 1026 may transfer information indicating that PDU set #2 has been discarded to the CU-UP 1024. At this time, packets belonging to PDU set #2 stored in the DU 1026 may be discarded in operation S1080. The determination of discarding PDU set #2 in the DU 1026 may be made according to the method described above in the disclosure (e.g., a determination of discarding based on expiration of a discard timer configured for each packet unit). In operation S1070, the CU-UP 1024 having received information indicating that PDU set #2 has been discarded from the DU 1026 may discard packets belonging to PDU set 2, which are stored in the CU-UP 1024, in operation S1090.

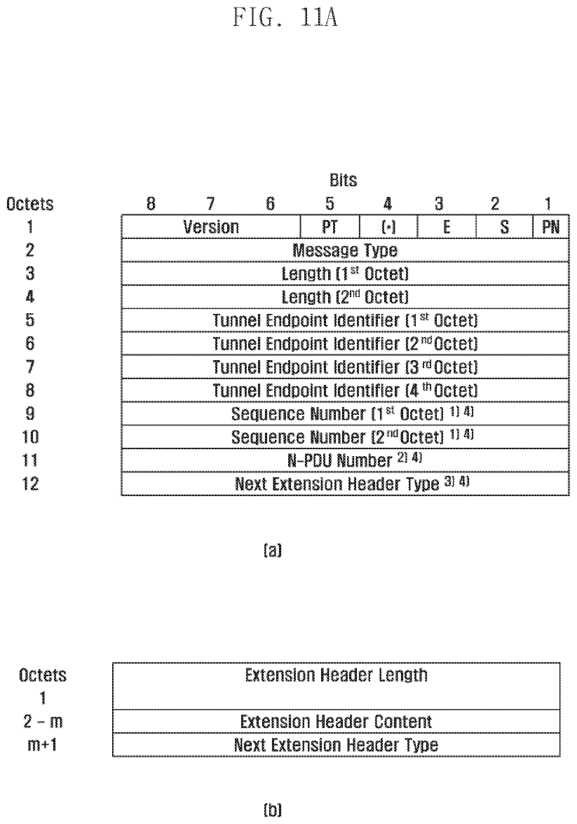

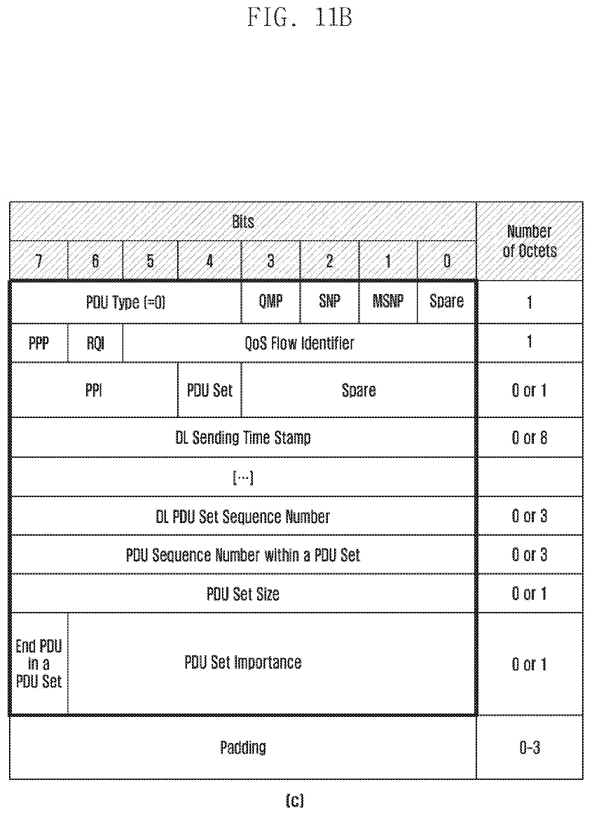

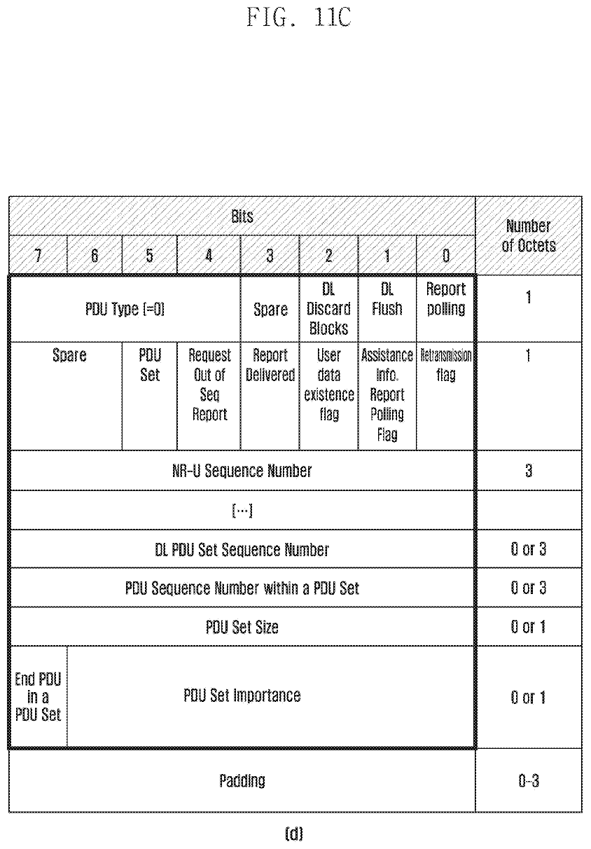

FIGS. IlA to 11C illustrate a configuration example of a packet transmitted by the UPF 1036 to the CU-UP 1024 in operation S1010 of FIG. 10 to support operation in units of a PDU set, and a configuration example of information included in a packet transmitted by the CU-UP 1024 to the DU 1026 in operation S1020 to support operation in units of a PDU set. The names of the fields included in FIGS. 11A to 11C are one example, and may be defined by other names having the same function, or the values included in the fields may be defined and used differently. Between the UPF 1036 and the CU-UP 1024, a user plane protocol of an NG-U interface may be used as an example. Between the CU-UP 1024 and the DU 1026, a user plane protocol of an F1-U interface may be used. In other user plane interfaces used in the mobile communication network, for example, a user plane protocol of interfaces such as S1-U, X2-U, Xn-U, W1-U, and the like, the example configurations of FIG. 11A to FIG. 11C may also be used.

(a) in FIG. 11A illustrates an example of a header configuration of a GTP-U protocol used for packet transmission between the UPF 36 and the CU-UP 24 and for packet transmission between the CU-UP 24 and the UPF 36. In addition to the basic header information, an extension header may be defined and included in the GTP-U header. (b) in FIG. 11A illustrates a configuration example of an extension header. The extension header may include length information and content, and may further include an extension header.

(c) in FIG. 11B illustrates a configuration example of a frame format included in an extension header used during packet transmission between the UPF 36and the CU-UP 24. In addition to the existing information used when transmitting packets between the existing UPF 36 and the CU-UP 24, a PDU Set Indicator field of one bit (bit) may be added for operation in units of a PDU set. In the case that the PDU Set Indicator bit is configured as “1”, “DL PDU Set Sequence Number”, “PDU Sequence Number within a PDU Set”, “PDU Set Size”, “End PDU in a PDU Set”, and “PDU Set Importance” information may be included, and all of the information may be included or one or more of the information may be included according to a separate definition or configuration. The “DL PDU Set Sequence Number” indicates a sequence number of a PDU set to which a transmitted packet belongs, and a “PDU Sequence Number within a PDU Set” indicates a packet sequence number within the PDU set of the corresponding packet. The “PDU Set Size” indicates the total size of the PDU set, and “End PDU in a PDU Set” indicates an indicator that the packet being transmitted is a packet that is finally transmitted among the packets belonging to the corresponding PDU set. The “PDU Set Importance” indicates a relative importance level or a predefined importance level of the PDU set to which the packet to be transmitted belongs, compared to other PDU sets.

(d) in FIG. 11C illustrates a configuration example of a frame format included in an extension header used during packet transmission between the CU-UP 1024 and the DU 1026. In addition to the existing information used for packet transmission between the CU-UP 1024 and the DU 1026, a 1-bit PDU Set Indicator field may be added for operation in units of a PDU set. When the PDU Set Indicator bit is configured as “1”, “DL PDU Set Sequence Number”, “PDU Sequence Number within a PDU Set”, “PDU Set Size”, “End PDU in a PDU Set”, and “PDU Set Importance” information may be included, and all of the information may be included, or one or more pieces of information may be included according to a separate definition or configuration. The “DL PDU Set Sequence Number” indicates a sequence number of a PDU set to which the transmitted packet belongs, and the “PDU Sequence Number within a PDU Set” indicates a packet sequence number of the packet within the PDU set. The “PDU Set Size” indicates the total size of a PDU set, and the “End PDU in a PDU Set” indicates an identifier indicating that the packet being transmitted is a packet that is finally transmitted among packets belonging to the PDU set. The “PDU Set Importance” indicates a relative importance level of the PDU set to which the packet to be transmitted belongs, compared with other PDU sets, or a pre-defined importance level assigned to the PDU set.

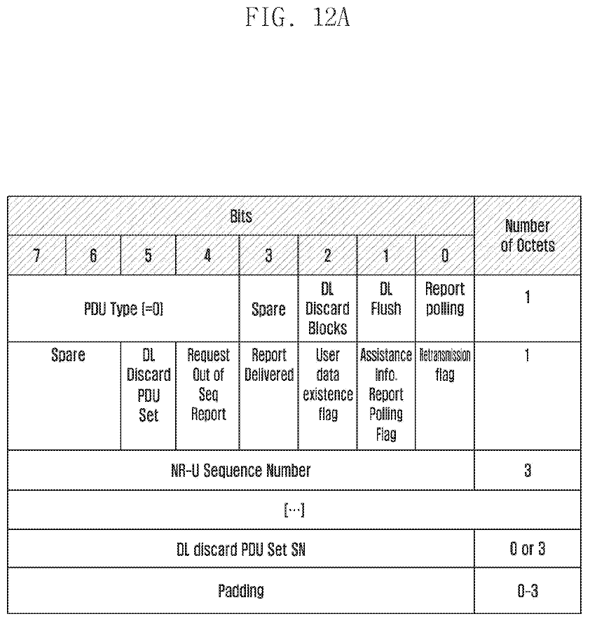

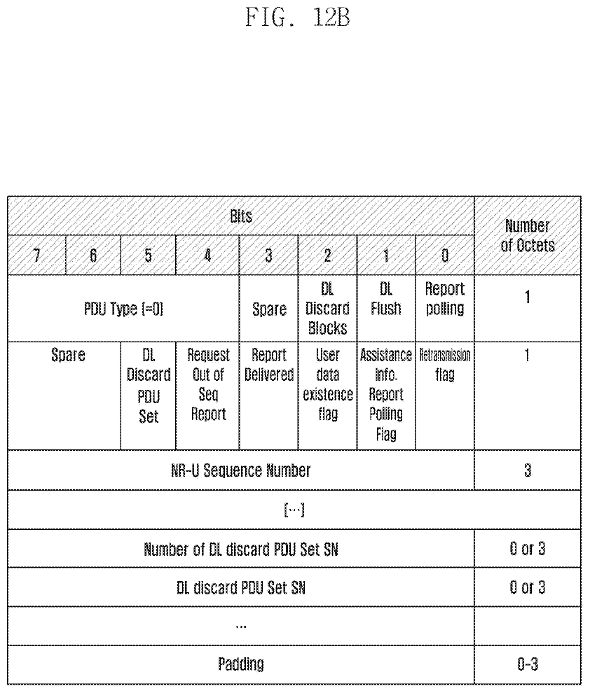

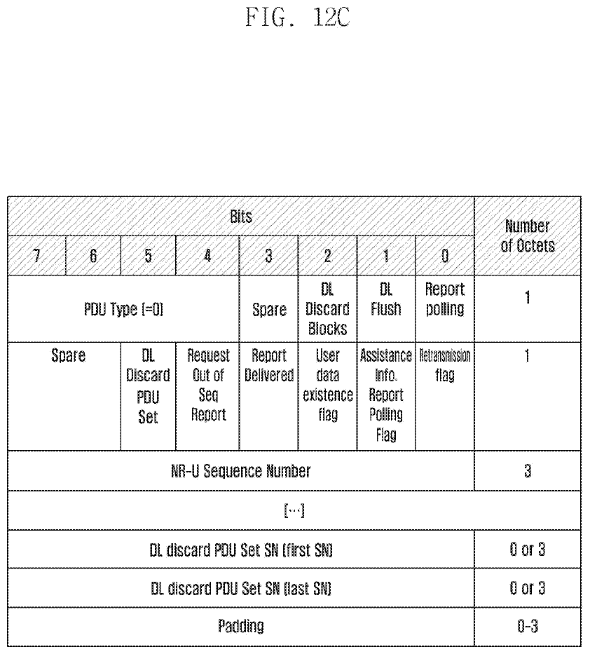

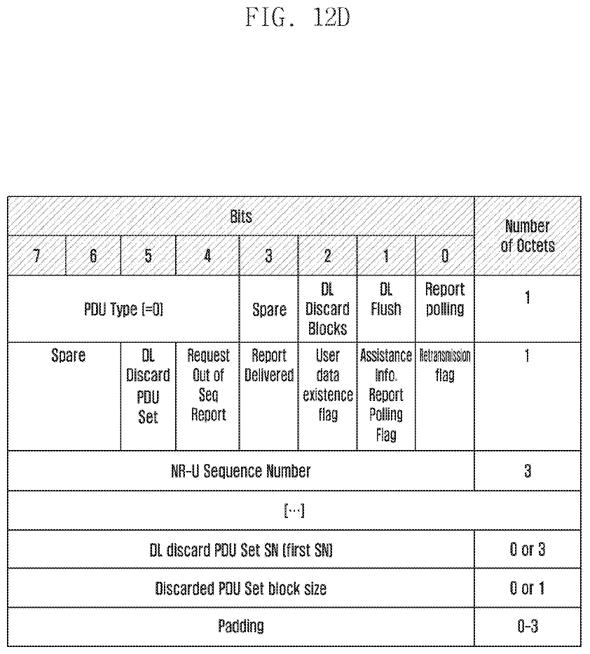

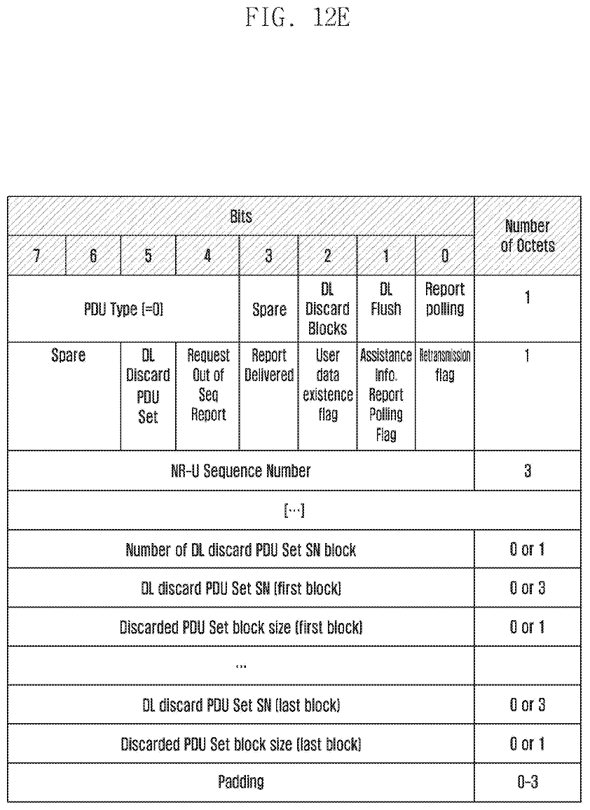

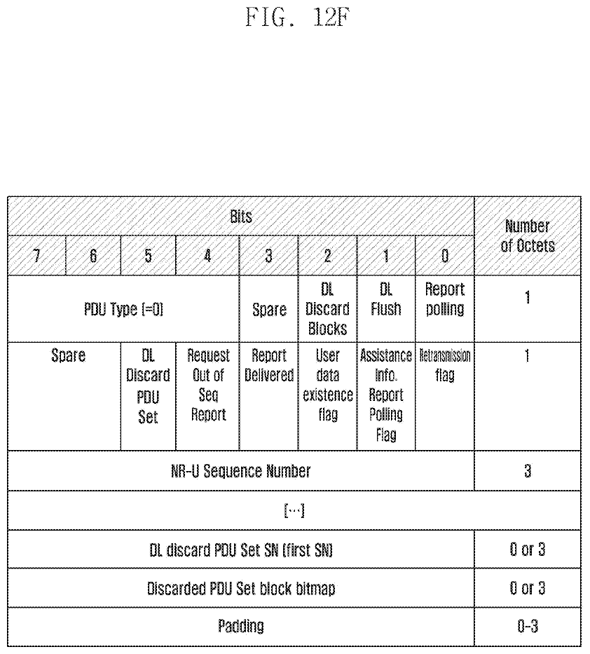

Meanwhile, FIGS. 12A to 12F illustrate configuration examples of information included in a packet used by a DU 1026 to transfer PDU set discarding information to a CU-UP 1024 in operation S1070 of FIG. 10 according to an embodiment. In order to transfer the PDU set discarding information to the CU-UP 1024, the DU 1026 may use a DL DATA DELIVERY STATUS (PDU Type 1) format used in F1-U or W1-U, for example. In addition, the field names included in FIGS. 12A to 12F may be defined by other names having the same function, and values included in the field may be defined and used differently. Although the DU 1026 may use another format to transmit PDU set discarding information to the CU-UP 1024, the DU 1026 may transmit the information including the examples illustrated in FIGS. 12A to 12F. FIGS. 12A to 12F are diagrams illustrating that the DU 1026 may transfer PDU set discarding information to the CU-UP 1024 through the following method, and other methods may be defined and used.
Method 1: Discarded PDU Set Sequence Number
Method 2: List of sequence numbers of discarded PDU sets (List of discarded PDU Set Sequence Numbers)
Method 3: First and last sequence numbers of discarded PDU sets (First & last discarded PDU Set Sequence Number)
Method 4: First sequence number of discarded PDU sets and the number of consecutive discarded PDU sets (First discard PDU Set Sequence Number and discarded block size)
Method 5: List of first sequence number of discarded PDU sets and the number of consecutive discarded PDU sets (List of discard PDU Set Sequence Number start and block size)
Method 6: First sequence number of discarded PDU sets and a bitmap indicating whether subsequent PDU sets are discarded (First discard PDU Set Sequence Number & bitmap for the following PDU Set Sequence Number)

FIG. 12A illustrates a configuration example of a DATA DELIVERY STATUS format in a method (Method 1), in which the DU 1026 transmits PDU set discarding information to the CU-UP 1024 by including a discarded PDU set sequence number (Discarded PDU Set Sequence Number). In addition to the existing information used for transmitting the DATA DELIVERY STATUS from the DU 1026 to the CU-UP 1024, a 1-bit “DL Discard PDU Set” field indicating inclusion of discarding information in units of a PDU set may be added. When the “DL Discard PDU Set” bit is configured as ‘1’, “DL Discard PDU Set SN” information may be included. The “DL Discard PDU Set SN” may include a sequence number of a PDU set to be discarded.

FIG. 12B illustrates a configuration example of a DATA DELIVERY STATUS format of a method (Method 2), in which the DU 1026 transmits PDU set discarding information to a CU-UP 1024 by including information of a list of discarded PDU set sequence number (List of discarded PDU Set Sequence Number). In addition to existing information used for transmitting the DATA DELIVERY STATUS from the DU 1026 to the CU-UP 1024, a 1-bit “DL Discard PDU Set” field indicating inclusion of discarding information in units of a PDU set may be added. When the “DL Discard PDU Set” bit is configured as “1”, “Number of DL discard PDU Set SN” and “DL discard PDU Set SN” information may be included. The “number of DL discard PDU Set SN” indicates the number of included PDU set sequence numbers, and “DL Discard PDU Set SN” information may be included as many as the number indicated by the “Number of DL Discard PDU Set SN.” The “DL discard PDU Set SN” may include a sequence number of a PDU set to be discarded.

FIG. 12C illustrates a configuration example of a DATA DELIVERY STATUS format of a method (Method 3), in which the DU 1026 transmits PDU set discarding information to the CU-UP 1024 by including information on first and last sequence numbers of discarded PDU sets (first & last DL discarded PDU set sequence number). In addition to existing information used for transmitting the DATA DELIVERY STATUS from the DU 1026 to the CU-UP 1024, a 1-bit “DL Discard PDU Set” field indicating inclusion of discarding information in units of a PDU set may be added. When the “DL Discard PDU Set” bit is configured as “1”, “DL discard PDU Set SN (first SN)” and “DL discard PDU Set SN (last SN)” information may be included. The information indicates that all PDU sets from the PDU set sequence number designated by the “DL discard PDU Set SN (first SN)” to the PDU set sequence number designated by the “DL discard PDU Set SN (last SN)” have been discarded.

FIG. 12D illustrates a configuration example of a DATA DELIVERY STATUS format of a method (Method 4), in which the DU 1026 transmits PDU set discarding information to the CU-UP 1024 by including information on a first sequence number of discard PDU sets and the number of consecutive discarded PDU sets (First discard PDU Set Sequence Number and discarded block size). In addition to existing information used for transmitting the DATA DELIVERY STATUS from the DU 1026 to the CU-UP 1024, a 1-bit “DL Discard PDU Set” field indicating inclusion of discarding information in units of a PDU set may be added. When the “DL Discard PDU Set” bit is configured as “1”, “DL discard PDU Set SN (first SN)” and “DL discard PDU Set block size” information may be included. The information indicates that all the PDU sets having consecutive PDU set sequence numbers, as many as the number of PDU sets of the “Discarded PDU Set block size”, starting from the PDU set sequence number designated by the “DL Discard PDU Set SN (first SN)”, have been discarded.

FIG. 12E illustrates a configuration example of a DATA DELIVERY STATUS format of a method (Method 5), in which the DU 1026 transmits PDU set discarding information to the CU-UP 1024 by including information on a list of a first sequence number of discard PDU sets and the numbers of consecutive discarded PDU sets (List of discard PDU Set Sequence Number start and block size). In addition to existing information used for transmitting the DATA DELIVERY STATUS from the DU 1026 to the CU-UP 1024, a 1-bit “DL Discard PDU Set” field indicating inclusion of discarding information in units of a PDU set may be added. When the “DL Discard PDU Set” bit is configured as “1”, “Number of DL discard PDU Set SN block”, “DL discard PDU Set SN (first SN)”, and “Discarded PDU Set block size” information may be included. The “Number of DL Discard PDU Set SN block” indicates the number of “DL Discard PDU Set SN (first SN)” and “Discarded PDU Set block size” to be included, and indicates that all PDU sets having consecutive PDU set sequence numbers, as many as the number of PDU sets of the “Discarded PDU Set block size,” starting from the PDU set sequence number designated by the “DL Discard PDU Set SN (first SN)”, have been discarded.

FIG. 12F illustrates a configuration example of a DATA DELIVERY STATUS format of a method (Method 6), in which the DU 1026 transmits PDU set discarding information to the CU-UP 1024 by including information on a first sequence number of discard PDU sets and a bitmap indicating whether subsequent consecutive PDU sets are discarded (First discard PDU Set Sequence Number & Bitmap for the Following PDU Set Sequence Numbers)”. In addition to the existing information used for transmitting the DATA DELIVERY STATUS from the DU 1026 to the CU-UP 1024, a 1-bit “DL Discard PDU Set” field indicating inclusion of discarding information in units of a PDU set may be added. When the “DL Discard PDU Set” bit is configured as “1”, the “DL discard PDU Set SN (first SN)” and the “Discarded PDU Set block bitmap” information may be included. The “DL Discard PDU Set SN (first SN)” indicates the sequence number of a first PDU set to be discarded. The “Discarded PDU Set block bitmap” is mapped to each bit in the order of subsequent PDU set sequence numbers, and indicates whether the PDU set of the corresponding sequence number is discarded.”

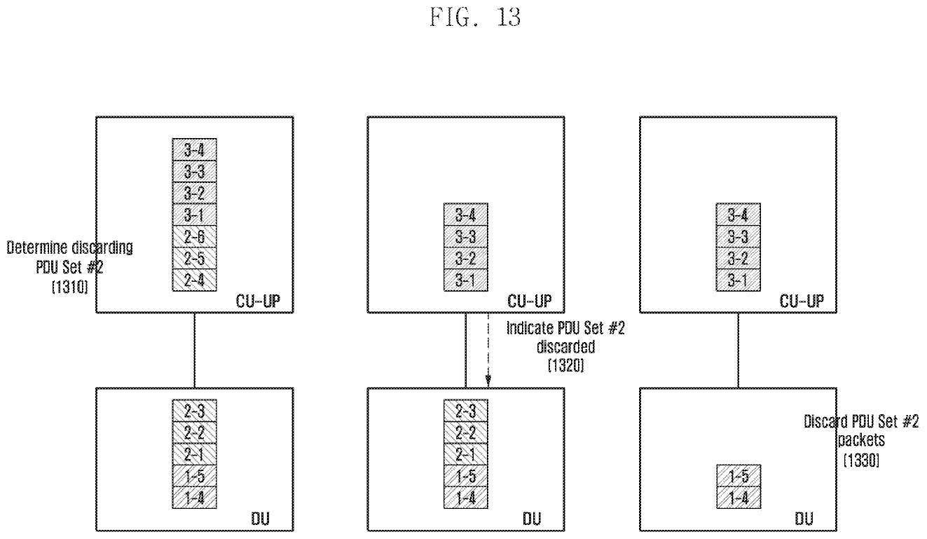

Meanwhile, FIG. 13 illustrates an operation for performing packet discarding in units of a PDU set in a CU-UP and a DU of an RAN node according to an embodiment of the disclosure. FIG. 13 illustrates a series of procedures for, in case that a packet belonging to one PDU set is discarded in a CU-UP, discarding packets belonging to the same PDU set stored in the CU-UP, and transferring information on the PDU set to be discarded to the DU to discard packets belonging to the corresponding PDU set in the DU.

In operation 1310 of FIG. 13, the CU-UP may determine to discard packets belonging to PDU set #2 and discard the packets of PDU set #2. In operation 1320, the CU-UP may transfer information indicating that PDU set #2 has been discarded to the DU. The PDU set information discarded in operation 1320 may be transferred to the DU by using a packet transferred through the user plane of the F1-U or W1-U interface between the CU-UP and the DU, or may be transferred to the CU-CP by an E1AP signaling message transferred through the control plane of the E1 interface by the CU-UP, and then transferred to the DU by an F1AP or W1AP signaling message transferred through the control plane of the F1-C or W1-C interface by the CU-CP. In operation 1320, the DU having received the PDU set #2 discarding information from the CU-UP may discard packets belonging to PDU set #2, which are stored, in operation 1330, and may also discard packets belonging to PDU set #2, which are later transferred from the CU-UP.

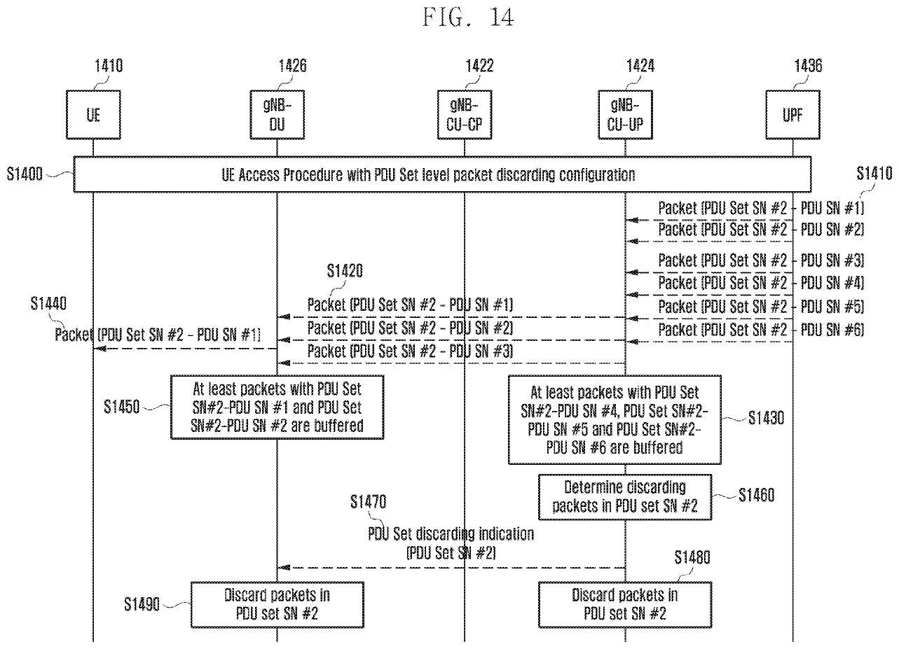

FIG. 14 is a sequence diagram illustrating an operation for performing packet discarding in units of PDU sets in a CU-UP and a DU of an RAN node according to an embodiment of the disclosure. Specifically, FIG. 14 illustrates, in a case in which a CU-UP discards packets belonging to one PDU set, operations and signaling procedures of each node or function for discarding packets belonging to the same PDU set stored in the CU-UP, and for transmitting information on the discarded PDU set to the DU so as to support the DU in performing an operation of discarding packets belonging to the corresponding PDU set.

Referring to FIG. 14, in operation S1400, a UE 1410 may perform a procedure for connection to an RAN node and a core network. In this case, the configuration for packet transmission in units of a PDU set and for discarding packets in units of a PDU set is configured in the UE 1410, a UPF 1436, and a CU-CP 1422, a CU-UP 1424, and a DU 1426 of the RAN node. In operation S1410, the UPF 1436 may transmit, for example, packets having a PDU set number (#) configured as 2, and may transmit six packets having sequence numbers 1 to 6 corresponding to packets belonging to PDU set #2 to the CU-UP 24 of the RAN node. In operation S1410, when the UPF 1436 transmits a packet to the CU-UP 1424, the packet may include a configuration example of information included in the packet in order to support operation in units of a PDU set as illustrated in FIG. 11A to FIG. 11C. The CU-UP 1424 may store packets that have been received from the UPF 1436, and may then perform a series of processes (e.g., packet processing operations on a PDCP layer) and may then transfer the packets to the DU 1426. In the embodiment of FIG. 14, the CU-UP 1424 may transmit, to the DU 1426, packets having sequence numbers 1 to 3 among the 6 packets belonging to PDU set #2 received from the UPF 1436 in operation S1420, and may store packets having sequence numbers 4 to 6 belonging to PDU set #2 for transmission to the DU 1426 in operation S1430. The sequence number of a packet belonging to PDU set #2 transmitted from the CU-UP 1424 to the DU 1426 in operation S1420 may be the same as the sequence number of the PDU used when the UPF 1436 transmits to the CU-UP 1424, or may be used with a different sequence number configured by the CU-UP 1424 again. When the CU-UP 1424 transmits a packet to the DU 1426 in operation S1420, the information included in the packet to be transmitted may include a configuration example of information included in the packet, as illustrated in FIGS. 11A to 11C, to support operation in units of a PDU set. In the embodiment of FIG. 14, the same reference numerals are used to indicate the same or like elements for the sake of descriptive convenience. The DU 1426 having received packets belonging to PDU set #2 from the CU-UP 1424 may transmit the packets to the UE 1410. In operation S1440, among the packets belonging to PDU set #2 that have been delivered from the CU-UP 24, only the packet having sequence number 1 is in a transmitted state. In operation S1450, the DU 1426 may store the remaining packets belonging to PDU set #2 (e.g., the packets having sequence numbers 2 and 3) in order to transmit them to the UE 1410.

When it is determined to discard packets belonging to PDU set #2 stored in the CU-UP 1424 in operation S1460, the CU-UP 1424 may transfer, to the DU 1426, information indicating that PDU set #2 has been discarded, in operation S1470. In this case, the CU-UP 1424 may discard packets belonging to PDU set #2 stored therein in operation S1480. The determination of discarding of PDU set #2 in the CU-UP 1424 may be made according to the method described above in the disclosure (e.g., a determination of discarding based on expiration of a discard timer configured for each packet unit). In operation S1470, the DU 1426 having received information indicating that PDU set #2 has been discarded from the CU-UP 1424 may discard packets belonging to PDU set 2, which are stored in the DU 1426, in operation S1490.

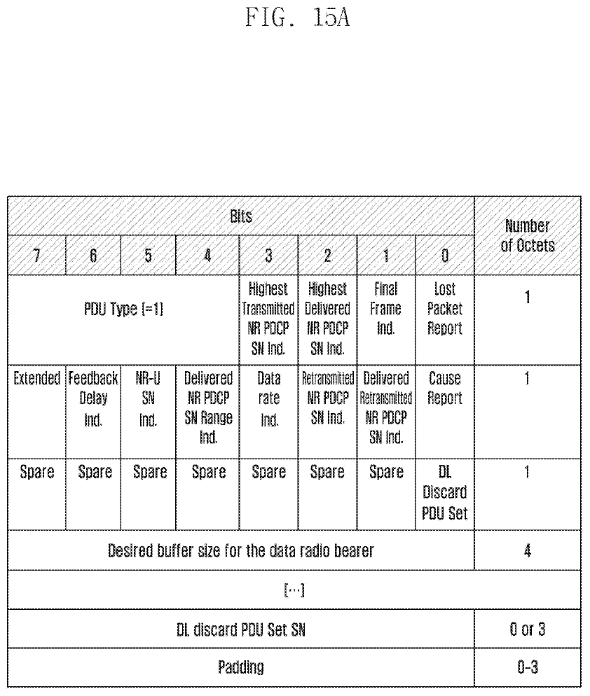

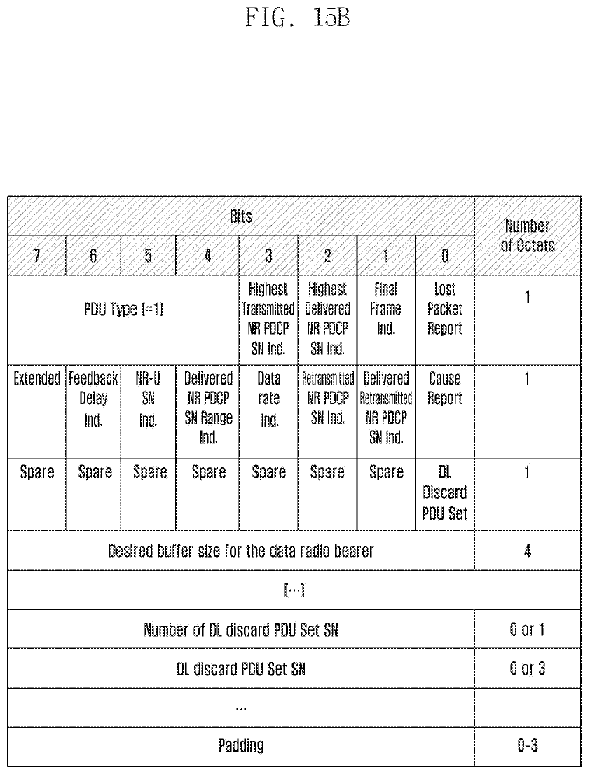

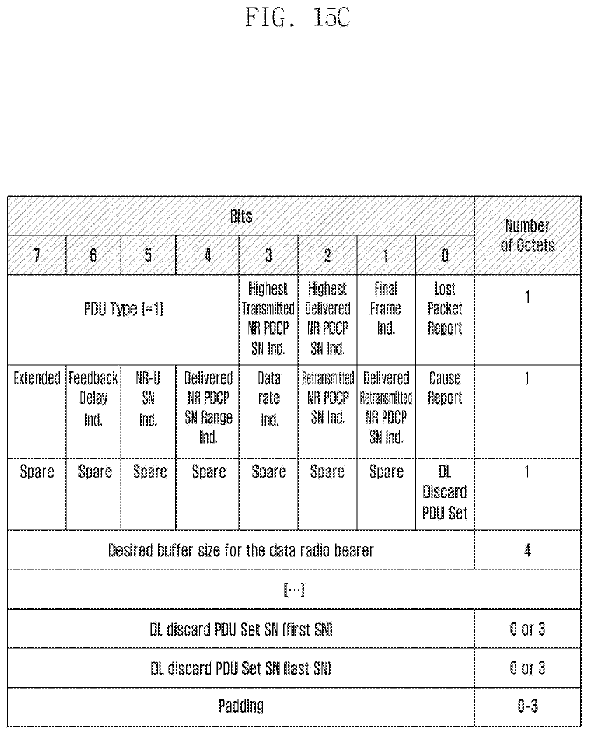

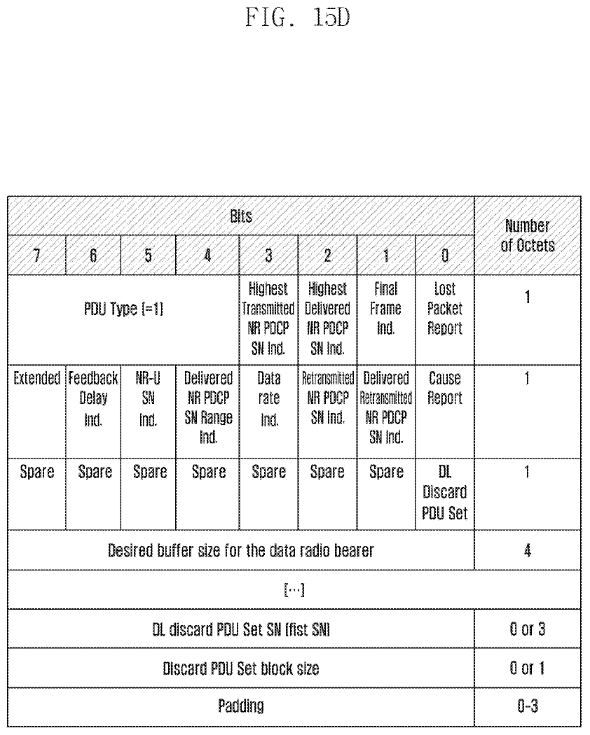

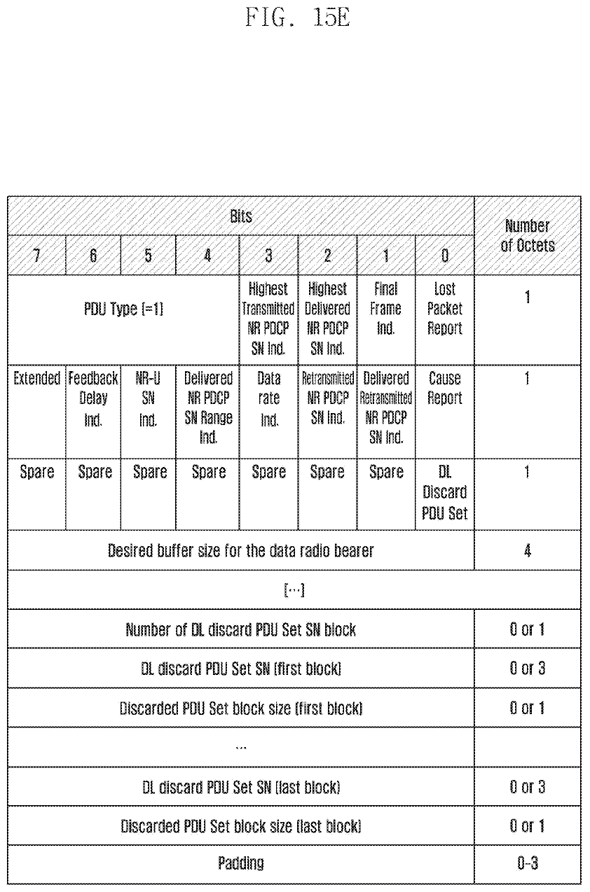

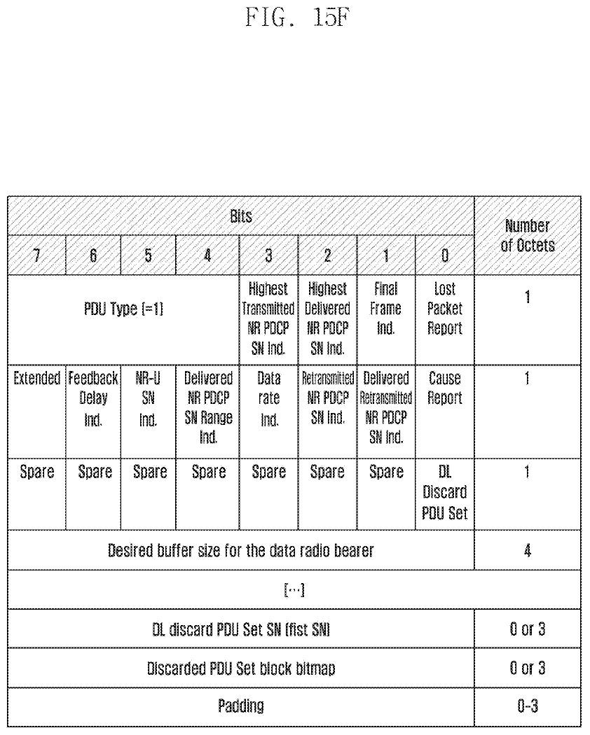

Meanwhile, FIGS. 15A to 15F illustrate examples of the configuration of information included in a packet used by the CU-UP 1424 to transfer PDU set discarding information to the DU 1426 in operation S1470 of FIG. 14 according to an embodiment. In order for the CU-UP 1424 to transfer PDU set discarding information to the DU 1426, a DL user data (PDU type 0) format used in F1-U or W1-U may be used, for example. In addition, the names of the fields included in FIG. 15A to FIG. 15F are merely examples, and may be defined by other names having the same functions or values included in the fields may also be defined and used differently. Although the CU-UP 1424 may use other formats to transfer PDU set discarding information to the DU 1426, the information illustrated in FIGS. 15A to 15F may be transmitted as an example thereof. FIGS. 15A to 15F illustrate that PDU set discarding information transferred by the CU-UP 1424 to the DU 1426 may be transferred in the following method as an example, and other methods may be defined and used.
Method 1: Discarded PDU Set sequence number
Method 2: List of sequence numbers of discarded PDU sets (List of discarded PDU Set Sequence Numbers)
Method 3: First and last sequence numbers of discarded PDU sets (First & Last discarded PDU Set Sequence Number)
Method 4: First sequence number of discarded PDU sets and the number of consecutive discarded PDU sets (First discard PDU Set Sequence Number and discarded block size)
Method 5: List of first sequence number of discarded PDU sets and the number of consecutive discarded PDU sets (List of discard PDU Set Sequence Number start and block size)
Method 6: First sequence number of discarded PDU sets and a bitmap indicating whether subsequent PDU sets are discarded (First discard PDU Set Sequence Number & bitmap for the following PDU Set Sequence Number)

FIG. 15A illustrates a configuration example of a DL USER DATA format in a method (Method 1), in which the CU-UP 1424 transmits PDU set discarding information to the DU 1426 by including a discarded PDU set sequence number (Discarded PDU Set Sequence Number). In addition to the existing information used for transmitting the DL USER DATA from the CU-UP 1424 to the DU 1426, a 1-bit “DL Discard PDU Set” field indicating inclusion of discarding information in units of a PDU set is included may be added. When the “DL Discard PDU Set” bit is configured as ‘1’, “DL Discard PDU Set SN” information may be included. The “DL Discard PDU Set SN” may include a sequence number of a PDU set to be discarded.

FIG. 15B illustrates a configuration example of a DL USER DATA format of a method (Method 2), in which the CU-UP 1424 transmits PDU set discarding information to the DU 1426 by including information of a list of discarded PDU set sequence number (List of discarded PDU Set Sequence Number). In addition to the existing information used for transmitting the DL USER DATA from the CU-UP 1424 to the DU 1426, a 1-bit “DL Discard PDU Set” field indicating inclusion of discarding information in units of a PDU set may be added. When the “DL Discard PDU Set” bit is configured as “1”, “Number of DL discard PDU Set SN” and “DL discard PDU Set SN” information may be included. The “number of DL discard PDU Set SN” indicates the number of included PDU set sequence numbers, and the “DL Discard PDU Set SN” information may be included as many as the number indicated by the “Number of DL Discard PDU Set SN.” The “DL discard PDU Set SN” may include a sequence number of a PDU set to be discarded.

FIG. 15C illustrates a configuration example of a DL USER DATA format of a method (Method 3), in which the CU-UP 1424 transmits PDU set discarding information to the DU 1426 by including information on first and last sequence numbers of discarded PDU sets (first & last DL discarded PDU set sequence number). In addition to the existing information used for transmitting the DL USER DATA from the CU-UP 1424 to the DU 1426, a 1-bit “DL Discard PDU Set” field indicating inclusion of discarding information in units of a PDU set may be added. When the “DL Discard PDU Set” bit is configured as “1”, “DL discard PDU Set SN (first SN)” and “DL discard PDU Set SN (last SN)” information may be included. The information indicates that all PDU sets from the PDU set sequence number designated by the “DL discard PDU Set SN (first SN)” to the PDU set sequence number designated by the “DL discard PDU Set SN (last SN)” have been discarded.

FIG. 15D illustrates a configuration example of a DL USER DATA format of a method (Method 4), in which the CU-UP 1424 transmits PDU set discarding information to the DU 1426 by including information on a first sequence number of discarded PDU sets and the number of consecutive discarded PDU sets (First discard PDU Set Sequence Number and discarded block size). In addition to the existing information used for transmitting the DL USER DATA from the CU-UP 24 to the DU 26, a 1-bit “DL Discard PDU Set” field indicating inclusion of discarding information in units of a PDU set may be added. When the “DL Discard PDU Set” bit is configured as “1”, “DL discard PDU Set SN (first SN)” and “DL discard PDU Set block size” information may be included. The information indicates that all the PDU sets having consecutive PDU set sequence numbers, as many as the number of PDU sets of the “Discarded PDU Set block size”, starting from the PDU set sequence number designated by the “DL Discard PDU Set SN (first SN)”, have been discarded.

FIG. 15E illustrates a configuration example of a DL USER DATA format of a method (Method 5), in which the CU-UP 1424 transmits PDU set discarding information to the DU 1426 by including information on a list of a first sequence number of discard PDU sets and the numbers of consecutive discarded PDU sets (List of discard PDU Set Sequence Number start and block size). In addition to the existing information used for transmitting the DL USER DATA from the CU-UP 1424 to the DU 1426, a 1-bit “DL Discard PDU Set” field indicating inclusion of discarding information in units of a PDU set may be added. When the “DL Discard PDU Set” bit is configured as “1”, “Number of DL discard PDU Set SN block”, “DL discard PDU Set SN (first SN)”, and “Discarded PDU Set block size” information may be included. The “Number of DL Discard PDU Set SN block” indicates the number of “DL Discard PDU Set SN (first SN)” and “Discarded PDU Set block size” to be included, and indicates that all PDU sets having consecutive PDU set sequence numbers, as many as the number of PDU sets of the “Discarded PDU Set block size,” starting from the PDU set sequence number designated by the “DL Discard PDU Set SN (first SN)”, have been discarded.

FIG. 15F illustrates a configuration example of a DL USER DATA format of a method (Method 6), in which the CU-UP 1424 transmits PDU set discarding information to the DU 1426 by including information on a first sequence number of discard PDU sets and a bitmap indicating whether subsequent consecutive PDU sets are discarded (First discard PDU Set Sequence Number & Bitmap for the Following PDU Set Sequence Numbers)”. In addition to the existing information used for transmitting the DL USER DATA from the CU-UP 1424 to the DU 1426, a 1-bit “DL Discard PDU Set” field indicating inclusion of discarding information in units of a PDU set may be added. When the “DL Discard PDU Set” bit is configured as “1”, the “DL discard PDU Set SN (first SN)” and the “Discarded PDU Set block bitmap” information may be included. The “DL Discard PDU Set SN (first SN)” indicates the sequence number of a first PDU set to be discarded. The “Discarded PDU Set block bitmap” is mapped to each bit in the order of subsequent PDU set sequence numbers, and indicates whether the PDU set of the corresponding sequence number is discarded.”

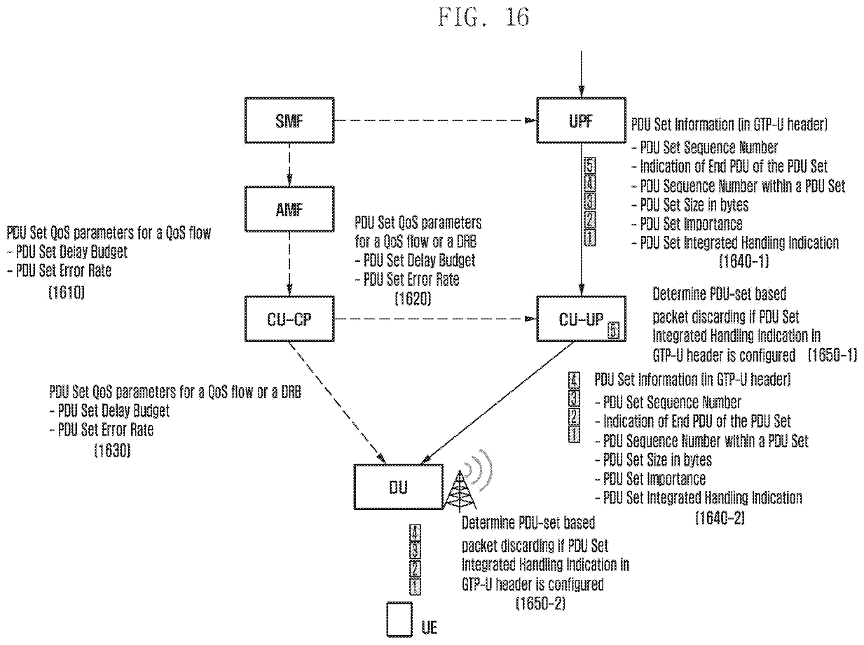

Meanwhile, FIG. 16 illustrates an operation for performing packet discarding in units of a PDU set in a CU-UP and a DU of an RAN node according to an embodiment of the disclosure. FIG. 16 illustrates an example of a series of procedure in which, based on PDU set integrated handling indication (PSIHI) information that is transmitted together with PDU set information in packets transmitted from a UPF to a CU-UP or from a CU-UP to a DU, the CU-UP or the DU determines whether to perform discarding in units of a PDU set, and performs the PDU set-based discarding accordingly.

In operation 1610 of FIG. 16, the SMF may transfer PDU Set QoS parameters, for example, PDU Set Delay Budget and PDU Set Error Rate information, for each QoS flow of a PDU session through the AMF. The CU-CP may determine whether to configure a resource for PDU session QoS flow service including PDU Set QoS parameters from the SMF/AMF, and in operation 1620, the CU-CP may transfer PDU set QoS parameter information to be configured for each QoS flow or for each DRB to the CU-UP. In operation 1630, the CU-CP may transfer PDU Set QoS parameters information to be configured for each QoS flow or for each DRB to the CU-UP. In operations 1620 and 1630, the CU-CP may, together with the PDU Set QoS parameters information, transfer additional information for supporting discarding in units of a PDU set, for example, a PDU set discard timer value. Thereafter, in operation 1640-1, when a packet is transferred from the UPF to the CU-UP, PDU set integrated handling indication (PSIHI) information may be included and transmitted together for each PDU set. In operation 1640-2, when the CU-UP transfers a packet to the DU, the CU-UP may transmit the same together with PDU set integrated handling indication (PSIHI) information for each PDU set. The PDU set integrated handling indication (PSIHI) information configured for each PDU set may indicate that, if at least one packet belonging to the corresponding PDU set fails to be successfully transmitted, the remaining packets belonging to the corresponding PDU set are regarded as meaningless. Therefore, in operations 1650-1 and 1650-2, when the CU-UP and the DU discard at least one packet belonging to a PDU set in which the PDU set integrated handling indication (PSIHI) is configured, the other packets belonging to the PDU set are also discarded. In addition, the CU-UP may transfer information regarding a discarded PDU set to the DU, and the DU may transfer the same to the CU-UP.

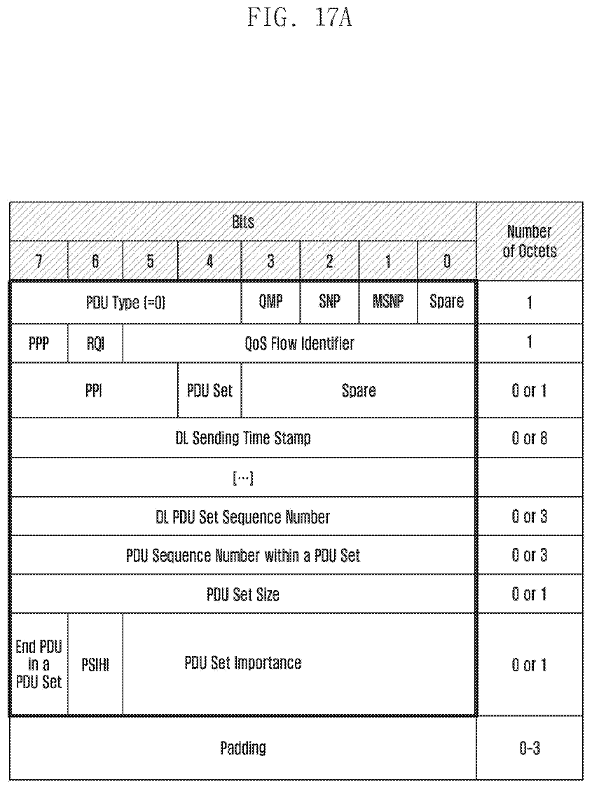

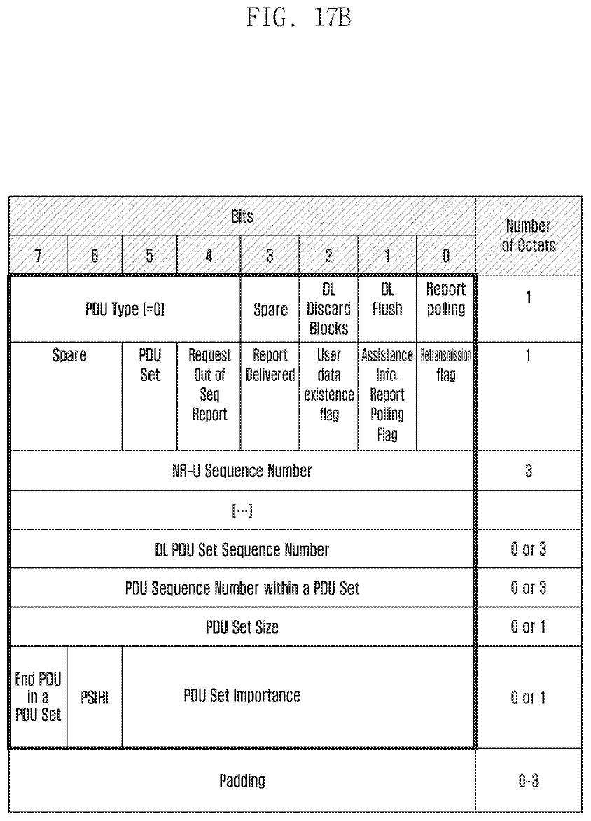

Meanwhile, FIG. 17A and FIG. 17B illustrate a configuration example of a packet transmitted by the UPF to the CU-UP to support operation in units of a PDU set in operation 1640-1 of FIG. 16, and a configuration example of information included in a packet transmitted by the CU-UP to the DU to support operation in units of a PDU set in operation 1640-2 of FIG. 16. The names of the fields included in FIGS. 17A and 17B are examples, and may be defined by other names having the same functions, or the values included in the fields may also be defined and used differently. A user plane protocol of a NG-U interface may be used between the UPF and the CU-UP, and a user plane protocol of an F1-U interface may be used between the CU-UP and the DU. The configuration examples of FIG. 17A and FIG. 17B may also be used in user plane protocols of other user plane interfaces used in a mobile communication network, for example, S1-U, X2-U, Xn-U, W1-U, and the like.

FIG. 17A illustrates a configuration example of a frame format included in an extension header used during packet transmission between a UPF and a CU-UP. In addition to the existing information used when transmitting packets between the existing UPF and the CU-UP, a PDU Set Indicator field of one bit (bit) may be added for operation in units of a PDU set. In the case that the PDU Set Indicator bit is configured as “1”, “DL PDU Set Sequence Number”, “PDU Sequence Number within a PDU Set”, “PDU Set Size”, “End PDU in a PDU Set”, “PDU set integrated handling indication (PSIHI)”, and “PDU Set Importance” information may be included, and all of the information may be included or one or more of the information may be included according to a separate definition or configuration. The “DL PDU Set Sequence Number” indicates a sequence number of a PDU set to which a transmitted packet belongs, and a “PDU Sequence Number within a PDU Set” indicates a packet sequence number within the PDU set of the corresponding packet. The “PDU Set Size” indicates the total size of the PDU set, and “End PDU in a PDU Set” indicates an indicator that the packet being transmitted is a packet that is finally transmitted among the packets belonging to the corresponding PDU set. The “PDU Set Integrated Handling Indication (PSIHI)” indicates that, if at least one packet belonging to the corresponding PDU set fails to be successfully transmitted, the remaining packets belonging to the same PDU set are regarded as meaningless, and the “PDU Set Importance” indicates a relative importance level of the PDU set to which the packet to be transmitted belongs, compared with other PDU sets, or a pre-defined importance level assigned to the PDU set.

FIG. 17B illustrates a configuration example of a frame format included in an extension header used during packet transmission between the CU-UP and the DU. In addition to the existing information used for packet transmission between the CU-UP and the DU, a 1-bit PDU Set Indicator field may be added for operation in units of a PDU set. When the PDU Set Indicator bit is configured as “1”, “DL PDU Set Sequence Number”, “PDU Sequence Number within a PDU Set”, “PDU Set Size”, “End PDU in a PDU Set”, “PDU set integrated handling indication (PSIHI)”, and “PDU Set Importance” information may be included, and all of the information may be included, or one or more pieces of information may be included according to a separate definition or configuration. The “DL PDU Set Sequence Number” indicates a sequence number of a PDU set to which the transmitted packet belongs, and the “PDU Sequence Number within a PDU Set” indicates a packet sequence number of the packet within the PDU set. The “PDU Set Size” indicates the total size of a PDU set, and the “End PDU in a PDU Set” indicates an identifier indicating that the packet being transmitted is a packet that is finally transmitted among packets belonging to the PDU set. The “PDU Set Integrated Handling Indication (PSIHI)” indicates that, if at least one packet belonging to the corresponding PDU set fails to be successfully transmitted, the remaining packets belonging to the same PDU set are regarded as meaningless, and the “PDU Set Importance” indicates a relative importance level of the PDU set to which the packet to be transmitted belongs, compared with other PDU sets, or a pre-defined importance level assigned to the PDU set.

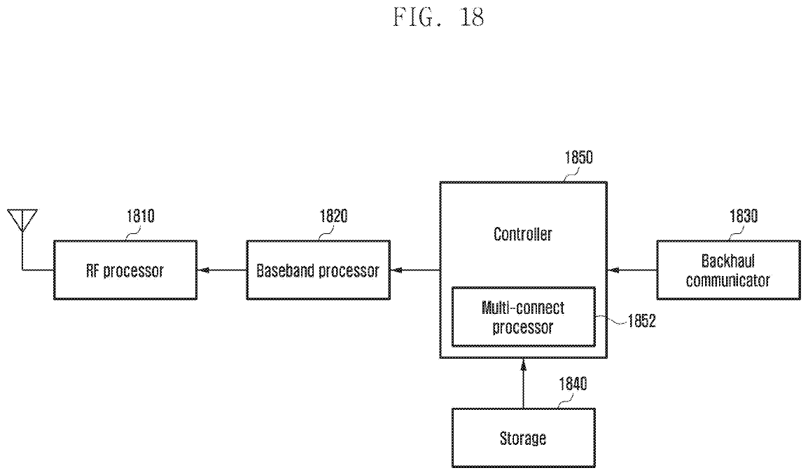

FIG. 18 is a block diagram illustrating a structure of an RAN node (e.g., base station) according to an embodiment of the disclosure. As illustrated in the drawing, the RAN node may include an RF processor 1810, a baseband processor 1820, a backhaul communicator 1830, a storage 1840, and a controller 1850. If the RAN node is divided into a central unit (CU) and a distributed unit (DU), then the block diagram may have a different structure from that included in FIG. 18. As an example, the RF processor 1810 and the baseband processor 1820 may be included in the DU, together with the controller, the storage, and the backhaul communicator for communication with the CU, and as an example, the backhaul communicator 1830 may be included in the CU, together with the controller, the storage, and the backhaul communicator for communication with the DU.

The RF processor 1810 may perform functions for transmitting/receiving signals through a radio channel, such as signal band conversion and amplification. The RF processor 1810 may up-convert a baseband signal provided from the baseband processor 1820 to an RF band signal, may transmit the same through an antenna, and may down-convert an RF band signal received through the antenna to a baseband signal. For example, the RF processor 1810 may include a transmission filter, a reception filter, an amplifier, a mixer, an oscillator, a DAC, and an ADC. Although only one antenna is illustrated in the drawing, the first access node may include multiple antennas. In addition, the RF processor 1810 may include multiple RF chains. Furthermore, the RF processor 1810 may perform beamforming. For the beamforming, the RF processor 1810 may adjust the phase and magnitude of signals transmitted/received through multiple antennas or antenna elements, respectively. The RF processor 1810 may transmit one or more layers to perform a downward MIMO operation.

The baseband processor 1820 may perform functions of conversion between baseband signals and bitstrings according to the physical layer specifications of first radio access technology. For example, during data transmission, the baseband processor 1820 may encode and modulate a transmitted bitstring to generate complex symbols. In addition, during data reception, the baseband processor 1820 may demodulate and decode a baseband signal provided from the RF processor 1810 to restore a received bitstring. For example, when following the OFDM scheme, during data transmission, the baseband processor 1820 may encode and modulate a transmitted bitstring to generate complex symbols, may map the complex symbols to subcarriers, and may configure OFDM symbols through IFFT operation and CP insertion. In addition, during data reception, the baseband processor 1820 may split a baseband signal provided from the RF processor 1810 at the OFDM symbol level, may restore signals mapped to subcarriers through FFT operation, and may restore a received bitstring through demodulation and decoding. The baseband processor 1820 and the RF processor 1810 may transmit and receive signals as described above. Therefore, the baseband processor 1820 and the RF processor 1810 may be referred to as a transmitter, a receiver, a transceiver, or a communicator.

The backhaul communicator 1830 provides an interface for communicating with other nodes in the network. The backhaul communicator 1830 may convert bitstrings transmitted from the main RAN node to other nodes (for example, auxiliary base station and core network) to physical signals, and may convert physical signals received from the other nodes to bitstrings.

The storage 1840 may store basic programs, application programs, and data, such as configuration information, for the operation of the main RAN node. Particularly, the storage 1840 may store information regarding a bearer allocated to a connected UE, a measurement result reported from the connected UE, and the like. In addition, the storage 1840 may store information serving as a reference to determine whether to provide multi-connectivity to a UE or to suspend the same. In addition, the storage 1840 provides the stored data at the request of the controller 1850.

The controller 1850 controls the overall operation of the RAN node. For example, the controller 1850 transmits/receives signals through the baseband processor 1820 and the RF processor 1810 or through the backhaul communicator 1830. In addition, the controller 1850 records data in the storage 1840 and reads the data from the storage 1840. To this end, the controller 1850 may include at least one processor. Also, the controller 1850 may be used to control the overall operation of the RAN node.

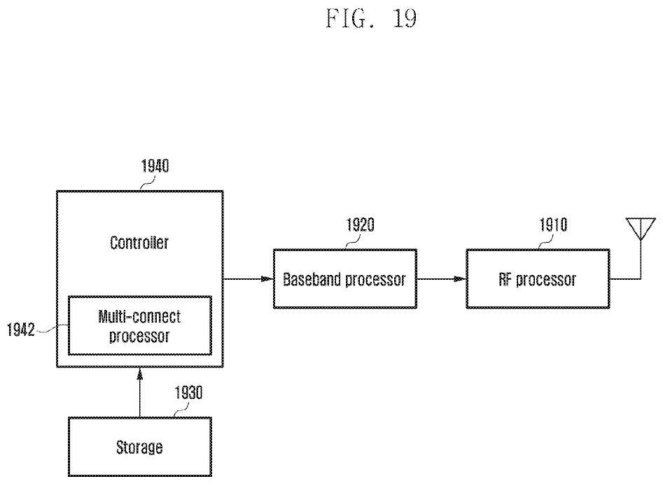

According to an embodiment of the disclosure, the controller 1850 may control the RAN node to perform the operation of discarding packets in units of PDU sets. If the RAN mode is divided into a CU and a DU, the controller 1850 may control the RAN node to generate and deliver messages transmitted from a CU-CP to a CU-UP or from the CU-CP to the DU. FIG. 19 is a block diagram illustrating a structure of a UE according to an embodiment of the disclosure. Referring to the drawing, the UE may include a radio frequency (RF) processor 1910, a baseband processor 1920, a storage 1930, and a controller 1940. The RF processor 1910 may perform functions for transmitting/receiving signals through a radio channel, such as signal band conversion and amplification. The RF processor 1910 may up-convert a baseband signal provided from the baseband processor 1920 to an RF band signal, may transmit the same through an antenna, and may down-convert an RF band signal received through the antenna to a baseband signal. For example, the RF processor 1910 may include a transmission filter, a reception filter, an amplifier, a mixer, an oscillator, a digital-to-analog converter (DAC), an analog-to-digital converter (ADC), and the like. Although only one antenna is illustrated in the drawing, the UE may include multiple antennas. In addition, the RF processor 1910 may include multiple RF chains. Furthermore, the RF processor 1910 may perform beamforming. For the beamforming, the RF processor 1910 may adjust the phase and magnitude of signals transmitted/received through multiple antennas or antenna elements, respectively. In addition, the RF processor may perform MIMO, and may receive multiple layers when performing a MIMO operation.

The baseband processor 1920 may perform functions of conversion between baseband signals and bitstrings according to the physical layer specifications of the system. For example, during data transmission, the baseband processor 1920 may encode and modulate a transmitted bitstring to generate complex symbols. In addition, during data reception, the baseband processor 1920 may demodulate and decode a baseband signal provided from the RF processor 1910 to restore a received bitstring. For example, when following the orthogonal frequency division multiplexing (OFDM) scheme, during data transmission, the baseband processor 1920 may encode and modulate a transmitted bitstring to generate complex symbols, may map the complex symbols to subcarriers, and may configure OFDM symbols through inverse fast Fourier transform (IFFT) operation and cyclic prefix (CP) insertion. In addition, during data reception, the baseband processor 1920 may split a baseband signal provided from the RF processor 1910 at the OFDM symbol level, may restore signals mapped to subcarriers through a fast Fourier transform (FFT) operation, and may restore a received bitstring through demodulation and decoding.

The baseband processor 1920 and the RF processor 1910 may transmit and receive signals as described above. Therefore, the baseband processor 1920 and the RF processor 1910 may be referred to as a transmitter, a receiver, a transceiver, or a communicator. Furthermore, at least one of the baseband processor 1920 and the RF processor 1910 may include multiple communication modules to support multiple different radio access technologies. In addition, at least one of the baseband processor 1920 and the RF processor 1910 may include different communication modules to process signals in different frequency bands. For example, the different radio access technologies may include a wireless LAN (e.g., IEEE 802.11), a cellular network (e.g., LTE), and the like. In addition, the different frequency bands may include super high frequency (SHF) (e.g., 2 NRHz) bands and millimeter wave (mmWave) (e.g., 60 GHz) bands.

The storage 1930 may store basic programs, application programs, and data, such as configuration information, for the operation of the UE. In addition, the storage 1930 may provide the stored data at the request of the controller 1940.

The controller 1940 controls the overall operation of the UE. For example, the controller 1940 may transmit/receive signals through the baseband processor 1920 and the RF processor 1910. In addition, the controller 1940 records data in the storage 1930 and reads the data from the storage 1930. To this end, the controller 1940 may include at least one processor. For example, the controller 1940 may include a communication processor (CP) configured to perform control for communication, and an application processor (AP) configured to control upper layers such as application programs.

According to an embodiment of the disclosure, there is provided a method for processing a control signal in a communication system, the method including receiving a first control signal between a central unit-control plane (CU-CP) and a central unit-user plane (CU-UP) in a split base station, and between the CU-CP and a Distributed Unit (DU); processing the received first control signal; and transmitting a second signal generated based on the processing. In addition, the method may include performing a PDCP SDU discard operation in units of a PDU set by a CU-UP and a DU and then transmitting a third control signal between the CU-UP and the DU, and processing the received third control signal and then performing a PDCP SDU discard operation in units of a PDU set.

The embodiments of the disclosure described and shown in the specification and the drawings are merely specific examples that have been presented to easily explain the technical contents of the disclosure and help understanding of the disclosure, and are not intended to limit the scope of the disclosure. It will be apparent to those skilled in the art that, in addition to the embodiments set forth herein, other variants based on the technical idea of the disclosure may be implemented.

1. A method performed by a base station in a wireless communication system, the method comprising:
transmitting, by a central unit (CU)-control plane (CP) to a CU-user plane (UP), at least one information for performing protocol data unit (PDU) set discarding, the at least one information for the PDU set discarding including discarding timer information; and
performing the PDU set discarding by the CU-CP.

2. The method of claim 1, further comprising:
transmitting, by the CU-CP to a distributed unit (DU), a message including information on configuration of the PDU set discarding; and
transmitting, by the DU to the CU-UP, at least one parameter associated with the PDU set discarding.

3. The method of claim 1, wherein the discarding timer information is transmitted while being included in packet data convergence protocol (PDCP) configuration information.

4. The method of claim 1, wherein the message including the information on configuration of the PDU set discarding comprises at least one of a user equipment (UE) context setup request message or a UE context modification request message.

5. The method of claim 1, wherein the information on configuration of the PDU set discarding comprises at least one of:
an indicator indicating inclusion of the information on configuration of the PDU set discarding;
a number of at least one PDU set for performing the PDU set discarding; or
a sequence number (SN) of at least one PDU set for performing the PDU set discarding.

6. The method of claim 1, further comprising receiving, from an access and mobility management function (AMF) entity, a message including at least one PDU set quality of service (QOS) parameter in which a PDU set integrity handling indication (PSIHI) is configured.

7. The method of claim 5, further comprising:
based on the message including the at least one QoS parameter in which the PSIHI is configured, applying the PSIHI to a QoS flow according to a PDU set; and
based on the PSIHI, determining whether to perform the PDU set discarding.

8. The method of claim 1, further comprising:
determining, by the CU-UP, discarding of a predetermined PDU set, at least one downlink packet included in the predetermined PDU set being stored in a buffer of the CU-UP; and
indicating, by the CU-UP to the DU, discarding of at least one downlink packet included in the predetermined PDU set and stored in a buffer of the DU.

9. A base station in a wireless communication system, the base station comprising a controller which is configured to:
control to transmit, by a central unit (CU)-control plane (CP) to a CU-user plane (UP), at least one information for performing protocol data unit (PDU) set discarding, the at least one information for the PDU set discarding including discarding timer information; and
control to perform, by the CU-CP, the PDU set discarding.

10. The base station of claim 9, wherein the controller is configured to:
control to transmit, by the CU-CP to a distributed unit (DU), a message including information on configuration of the PDU set discarding; and
control to transmit, by the DU to the CU-UP, at least one parameter associated with the PDU set discarding.

11. The base station of claim 9, wherein the discarding timer information is transmitted while being included in packet data convergence protocol (PDCP) configuration information.

12. The base station of claim 9, wherein the message including the information on configuration of the PDU set discarding comprises at least one of a user equipment (UE) context setup request message or a UE context modification request message.

13. The base station of claim 9, wherein the information on configuration of the PDU set discarding comprises at least one of:
an indicator indicating inclusion of the information on configuration of the PDU set discarding;
a number of at least one PDU set for performing the PDU set discarding; or
a sequence number (SN) of at least one PDU set for performing the PDU set discarding.

14. The base station of claim 9, further comprising a transceiver, wherein the controller is configured to:
control the transceiver to receive, from an access and mobility management function (AMF) entity, a message including at least one PDU set quality of service (QoS) parameter in which a PDU set integrity handling indication (PSIHI) is configured;
based on the message including the at least one QoS parameter in which the PSIHI is configured, perform control to apply the PSIHI to a QoS flow according to a PDU set; and
based on the PSIHI, perform control to determine whether to perform the PDU set discarding.

15. The base station of claim 9, wherein the controller is configured to:
control the CU-UP to determine discarding of a predetermined PDU set, at least one downlink packet included in the predetermined PDU set being stored in a buffer of the CU-UP; and
control the CU-UP to indicate, to the DU, discarding of at least one downlink packet included in the predetermined PDU set and stored in a buffer of the DU.
